(19) United States
(12) Patent Application Publication
(10) Pub. No.: US 2026/0073277 A1
(43) Pub. Date: Mar. 12, 2026

(54) AUTOMATED SOFTWARE APPLICATION DISTRIBUTION AND EXECUTION ON MULTI-NODAL DIGITAL SYSTEMS

(71) Applicant: Sophic Compute, Inc., Denver, CO (US)

(72) Inventor: Steve J. Frank, Denver, CO (US)

(21) Appl. No.: 18/827,800

(22) Filed: Sep. 8, 2024

(51) Int. Cl. G06N 20/00

(52) U.S. Cl. CPC G06N 20/00

(57) ABSTRACT

The invention provides for utilization of a machine learning (ML) subsystem on each node of a multi-node system to effect parallel execution of software applications across multiple nodes through interaction of the ML subsystems and through the exchange of objects (instruction, data, task and thread) that define the parallel execution. A method according to the invention includes executing software on a first processing element, intercepting instructions executed during execution of the software, applying a representation of the intercepted instructions to the ML subsystem to generate action outputs to effect further execution of the software on multiple processing elements, generating objects associated with the software and/or with data to be processed thereby, and making the action outputs and/or object(s) available to multiple processing elements to effect such further execution.

### REFERENCE TO RELATED APPLICATIONS

This application is related to the following co-pending, commonly assigned applications, the teachings of all of which are incorporated by reference herein:
U.S. patent application Ser. No. ______, Filed Sep. 8, 2024, Entitled “AUTOMATED SOFTWARE APPLICATION PARALLELIZATION AND EXECUTION ON MULTI-CORE DIGITAL SYSTEMS”, Attorney Docket 017086.0002.PRI.US.
U.S. patent application Ser. No. ______, Filed Sep. 8, 2024, Entitled “COMMUNICATION PROTOCOL FOR DISTRIBUTED PROCESSING OF SOFTWARE APPLICATIONS”, Attorney Docket 017086.0004.PRI.US.
U.S. patent application Ser. No. ______, Filed Sep. 8, 2024, Entitled “COORDINATED PARALLELIZATION AND EXECUTION OF SOFTWARE APPLICATIONS”, Attorney Docket 017086.0005.PRI.US.

### BACKGROUND OF THE INVENTION

The invention relates to digital data processing and, more particularly, to methods and apparatus for automated distribution and execution of software applications on multi-core and multi-nodal digital systems. The invention has application in improving the execution of a broad range of digital twin, machine learning and other complex software applications.

Early computers typically relied on a single central processing unit, or CPU, to perform processing functions. Source code programs written for those computers were translated into a sequence of machine instructions for execution one-by-one on the CPU. A later advance made it possible to execute some instructions of a computer program in parallel with other instructions of that same program. This was supported, in the early days, by special-purpose floating-point and video display “co-processors” that operated alongside the CPU.

With the advent of computers with multiple general-purpose processors, it has become possible to allocate entire tasks to separate concurrently operating CPUs. A special class of these multiprocessors, referred to as parallel processors, are equipped with special synchronizing mechanisms and thus are particularly suited for concurrently executing portions of the same program. Unfortunately, rewriting software applications so that they can run efficiently on parallel processors is a task of such complexity that it is a niche job specialty.

The need for those skills has narrowed with the rise of the graphics processing unit. Originally purpose-built to handle 3D graphics on single-CPU systems, GPUs are increasingly employed on smart phones, portable computers, workstations and other “personal” computing devices for matrix processing and other tasks, like artificial intelligence, that are suited to parallel execution. Because these platforms are relatively constrained, parallelizing software for execution on them can be automated and is a regular function of compilers and related software development tools.

Notwithstanding the fervor, GPUs are not suitable for many software tasks. Their hyperfocus on repetitive calculations renders them ineffective, at best, at the administrative and executive tasks required to execute most software applications. Hence, GPUs are typically ganged to a CPU that handles those tasks for the collective bunch.

While a multiprocessor or, more generally, a distributed platform of CPUs (whether or not ganged with GPUs) might be better suited to executing some, if not most, software applications in parallel, breaking up or parallelizing different portions of an application with differing techniques (often, in explicitly parallelized code of the sort illustrated in FIG. 8) for such execution is beyond the ken of the ever-diminishing pool of suitably-skilled software engineers. And even those up to such a task are often burdened by a myopic “one strategy” approach that can prove less than optimal. Moreover, although the art provides multiprocessor development environments, such as OpenMP, OpenMPI and CUDA, specifically designed to facilitate parallelization, even these require expert skill to use and are, likewise, burdened by a “one strategy” approach.

This is particularly evident for software applications that mimic real-world objects-so-called digital twins. It is often not enough for these applications to complete tasks as soon as possible. Digital twins must match, if not exceed, the operational speeds of portions of, if not entire, physical systems including biological systems and, often, must combine different physical systems together to match a particular real world environment. Depending on the physical system, different simulations required across mechanical, chemical, electrical, biological and molecular aspects must often be combined together. Non-limiting examples of digital twins are an entire operating factory or a portion of the human body undergoing surgery. Parallelizing a multitude of software applications and their interactions for execution on multiprocessors or distributed systems at those speeds and complexity can be beyond the ken of even the most adept software engineers.

An object of this invention is to provide improved digital processing apparatus and methods.

Another object of the invention is to provide such apparatus and methods as facilitate distribution and execution of all or portions of a software application on multiple processors (or “cores”) within a digital data apparatus and on multiprocessing systems such as, for example, distributed processing systems.

Yet still another object of the invention is to provide such apparatus and methods as facilitate parallel execution of such an application (or portions thereof) on a dynamically changing and/or heterogeneous processing systems, e.g., without requiring specialized coding or software development for the various processors that make up those systems.

Still yet another object of the invention is to provide such apparatus and methods as can be implemented in an automated fashion, e.g., without substantial involvement of software engineers to “parallelize” the applications.

### SUMMARY OF THE INVENTION

### Automated Software Application Parallelization and Execution on Multi-Core Digital Systems

The foregoing are among the objects attained by the invention, which provides, in some aspects, a method of executing software that includes the steps of (A) executing software on a first processor core to process a set of data; (B) detecting or intercepting (collectively, “intercepting”) one or more instructions executed by the first processor core during and as a result of its execution of the software; (C) applying a representation of one or more of the intercepted instructions to an artificial intelligence (AI) engine to generate, using a machine learning (ML) model executing on that AI engine, one or more action outputs of the ML model that include commands to effect further execution of at least portions of the software on multiple processor cores to process at least portions of the data; and, (D) responding to one or more of those action outputs to effect execution of portions of the software on multiple processor cores to process at least portions of the set of data.

In related aspects, the invention provides methods of software execution, e.g., as described above, in which step (C) includes generating the one or more action outputs to include commands to effect further execution of at least portions of the software in parallel on the multiple processor cores to process at least portions of the set of data thereon.

Further related aspects of the invention provide methods of software execution, e.g., as described above, wherein step (C) includes generating the one or more action outputs to include commands to effect further execution of at least portions of the software in series on the multiple processor cores to process at least portions of the set of data thereon.

Still further related aspects of the invention provide methods of software execution, e.g., as described above, wherein step (C) includes generating the one or more action outputs to include commands to effect further execution of at least portions of the software on multiple processor cores of a common processing element to process at least portions of the set of data thereon, where the common processing element includes the first processor core.

Yet still further related aspects of the invention provide methods of software execution, e.g., as described above, wherein step (C) includes generating the one or more action outputs to include commands to effect further execution of at least portions of the software on processor cores of multiple processing elements to process at least portions of the set of data thereon, where at least one of those multiple processing elements does not include the first processor core.

Still yet further related aspects of the invention provide methods of software execution, e.g., as described above, wherein step (C) includes generating the one or more action outputs to include commands to effect further execution of at least portions the software on processor cores of multiple processing elements to process at least portions of the set of data thereon, and where at least one of those processing elements does not include the first processor core, and where at least one of those processing elements includes the first processor core.

Yet still further related aspects of the invention provide methods of software execution, e.g., as described above, wherein step (B) includes executing an adapter on the first processor core to intercept the instruction and to generate therefrom the representation.

Still yet further related aspects of the invention provide methods of software execution, e.g., as described above, wherein the intercepted instruction includes a call instruction and wherein the adapter includes an interface to a function executing on the first processor core.

Yet still further related aspects of the invention provide methods of software execution, e.g., as described above, that include the step of using the adapter to convert one or more of the action outputs to a call or a modified form thereof for execution on the first processor core.

Still other related aspects of the invention provide methods of software execution, e.g., as described above, wherein step (C) includes using the ML model to identify a strategy to define any of the software and the set of data for execution on the multiple processor cores.

Yet still other related aspects of the invention provide methods of software execution, e.g., as described above, wherein step (C) includes generating the action outputs to include commands identifying any of software instructions to execute on each of the multiple processor cores and data to be processed during such execution by the respective processor cores.

Other aspects of the invention provide methods of software execution that include, alone or in combination with the methods above, the steps of (A) executing a software application on a first processing element; (B) any of detecting and intercepting (collectively, “intercepting”) one or more instructions executed by the first processing element during and as a result of its execution of the software application; (C) applying a representation of one or more of the intercepted instructions to an artificial intelligence (AI) engine to generate, using a machine learning (ML) model executing on that AI engine, one or more action outputs of the ML model that include commands to effect further execution of the software application; and (D) responding to one or more of those action outputs to further execute the software application.

Related aspects of the invention provide methods of software execution, e.g., as described above, wherein most-recently mentioned step (C) includes using the ML model to generate one or more action outputs including commands to effect the further execution on one or more processing elements other than the first processing element.

Other related aspects of the invention provide methods of software execution, e.g., as described above, wherein most-recently mentioned step (C) includes using the ML model to generate one or more action outputs to include commands to effect the further execution of the software on the first processing element.

Still other related aspects of the invention provide methods of software execution, e.g., as described above, wherein most-recently mentioned step (C) includes using the ML model to generate one or more action outputs to include commands to effect further execution of the software application on any of (i) the first processing element and (ii) one or more processing elements other than the first processing element.

Yet still other related aspects of the invention provide methods of software execution, e.g., as described above, wherein each of the processing elements executes a single instance of its own respective operating system.

Still yet other related aspects of the invention provide methods of software execution, e.g., as described above, wherein most-recently mentioned step (C) includes generating the one or more action outputs to include commands to effect execution of one or more of the intercepted instructions or a modified form thereof on the one or more processing elements other than the first processing element.

Yet still yet other related aspects of the invention provide methods of software execution, e.g., as described above, wherein most-recently mentioned step (C) includes generating the one or more action outputs to comprise commands to effect execution of one or more of the intercepted instructions or a modified form thereof on the first processing element.

Other related aspects of the invention provide methods of software execution, e.g., as described above, wherein most-recently mentioned step (C) includes generating the one or more action outputs to include commands to effect (i) execution of one or more of the intercepted instructions or a modified form thereof on the one or more processing elements other than the first processing element and (ii) execution of one or more of the intercepted instructions or a modified form thereof on the first processing element.

Still other related aspects of the invention provide methods of software execution, e.g., as described above, wherein most-recently mentioned step (C) includes executing the AI engine on the first processing element.

Still yet other related aspects of the invention provide methods of software execution, e.g., as described above, wherein the one or more intercepted instructions include a call executed by the first processing element to invoke a software library during its execution of the software.

Yet other related aspects of the invention provide methods of software execution, e.g., as described above, wherein most-recently mentioned step (B) includes executing an adapter on the first processing element to intercept the call and to generate therefrom the representation.

Yet still other related aspects of the invention provide methods of software execution, e.g., as described above, wherein the adapter includes an interface to the software library.

Still yet other related aspects of the invention provide methods of software execution, e.g., as described above, that include using the adapter to convert one or more of the action outputs to a call or a modified form thereof for execution on the first processing element.

Further related aspects of the invention provide methods of software execution, e.g., as described above, wherein most-recently mentioned step (B) includes interpreting source code and/or object code of the software, and most-recently mentioned step (C) includes generating, based on the interpreted source code and/or object code, one or more action outputs of the ML model to effect further execution of the software.

Still further related aspects of the invention provide methods of software execution, e.g., as described above, wherein the ML model includes a decision transformer, reinforcement learning (RL) or other ML techniques and/or optimizations thereof.

Yet still further related aspects of the invention provide methods of software execution, e.g., as described above, wherein the ML model is trained with labeled data, unlabeled data and/or synthetic generated data representing execution of one or more sets of instructions other than those defining the software.

Yet still yet further related aspects of the invention provide methods of software execution, e.g., as described above, wherein the ML model is trained during any of pre-runtime, runtime and update-training phases of execution of the software with labelled or unlabelled data representing execution of the software.

Yet other related aspects of the invention provide methods of software execution, e.g., as described above, wherein the ML model is trained during any of pre-runtime, runtime and update-training phases of execution of the software using, as a cost function, any of (a) a period of time for effecting further execution of the software in response to one or more of the action outputs on at least one of (i) the first processing element, and (ii) one or more processing elements other than the first processing element; and, (b) an amount of hardware resources required for effecting further execution of the software in response to one or more of the action outputs of the ML model on at least one of (i) the first processing element, and (ii) one or more digital processing devices other than the first processing element.

Yet still other related aspects of the invention provide methods of software execution, e.g., as described above, wherein most-recently mentioned step (C) includes logging inputs applied to the ML model and outputs generated thereby, and wherein the method further includes replaying the logged inputs and outputs to train the model during an update-training phase.

Other aspects of the invention provide methods of software execution that include, alone or in combination with the methods above, the steps of (A) executing a software application on a first processing element; (B) any of detecting and intercepting (collectively, “intercepting”) one or more instructions executed by the first processing element during and as a result of its execution of the software application; (C) generating a representation of one or more of the intercepted instructions; and (D) applying the representation to an artificial intelligence (AI) engine to generate, using a machine learning (ML) model executing on that AI engine, one or more action outputs of the ML model to effect (i) further execution of the software application on one or more processing elements other than the first processing element, and (ii) execution of one or more of the intercepted instructions or a modified form thereof on the first processing element.

Further related aspects of the invention provide methods of software execution, e.g., as described above, including responding to one or more of the action outputs by executing on the first processing element one or more of the intercepted instructions or a modified form thereof.

Still further related aspects of the invention provide methods of software execution, e.g., as described above, wherein most-recently mentioned step (D) includes generating the one or more action outputs to effect execution of one or more of the intercepted instructions or a modified form thereof on the one or more processing elements other than the first processing element.

Yet still further related aspects of the invention provide methods of software execution, e.g., as described above, wherein most-recently mentioned step (D) includes executing the AI engine on the first processing element.

Still yet further related aspects of the invention provide methods of software execution, e.g., as described above, wherein the ML model includes a decision transformer, reinforcement learning (RL) or other ML techniques and/or optimizations thereof.

Yet still further related aspects of the invention provide methods of software execution, e.g., as described above, wherein the ML model is trained with labeled data, unlabeled data and/or synthetic generated data representing execution of software other than the software application.

Yet still yet further related aspects of the invention provide methods of software execution, e.g., as described above, wherein the ML model is trained during any of pre-runtime, runtime and update-training phases of execution of the software with any of labeled data and unlabeled data representing execution of the software application.

Still yet further related aspects of the invention provide methods of software execution, e.g., as described above, wherein the ML model is trained during any of pre-runtime, runtime and update-training phases of execution of the software using, as a cost function, any of (a) a period of time for effecting further execution of the software application on at least one of (i) the first processing element, and (ii) one or more processing elements other than the first processing element, and (b) an amount of hardware resources required for effecting further execution of the software application in response to one or more of the action outputs on at least one of (i) the first processing element, and (ii) one or more processing elements other than the first processing element.

Still other related aspects of the invention provide methods of software execution, e.g., as described above, wherein most-recently mentioned step (D) includes logging inputs applied to the ML model and outputs generated thereby, and wherein the method further includes replaying the logged inputs and outputs to train the model during an update-training phase.

Other related aspects of the invention provide methods of software execution, e.g., as described above, where each said processing element comprises any of (i) one or more processor cores, including at least one central processing unit (CPU) core, graphics processing unit (GPU) core and/or specialized processing unit (SPU) core, (ii) a virtualization container executing on one or more processor cores, (iii) a virtual machine executing on such cores, and/or (iv) a combination of the foregoing.

Still other related aspects of the invention provide methods of software execution, e.g., as described above, where each said CPU, GPU and/or SPU (i) accesses local memory and I/O logic of the respective processing element by way of a shared local bus or backplane, and/or (ii) collectively, execute a single instance of an operating system.

### Automated Software Application Distribution and Execution on Multi-Nodal Digital Systems

The foregoing objects are also attained by the invention, which provides in some aspects a method of executing software on a digital system with multiple processing elements, including, alone or in combination with the methods above, the steps of (A) executing software on a first processing element of a digital system to process a set of data, where the digital system includes multiple processing elements, including the first processing element, that are coupled for communications; (B) any of detecting and intercepting (collectively, “intercepting”) one or more instructions executed by the first processing element during and as a result of its execution of the software; (C) applying a representation of one or more of the intercepted instructions to an artificial intelligence (AI) engine to generate, using a machine learning (ML) model executing on that AI engine, one or more action outputs of the ML model including commands to effect further execution of the software on multiple processing elements of the digital system; (D) generating based on those action outputs one or more objects that (i) are associated with instructions making up at least a portion of the software upon which such further execution is to be effected, and (ii) are associated with at least a subset of the set of data, in an address space common to the multiple processing elements, to be processed by those associated instructions, and (E) making available any of action outputs and objects to the multiple processing elements to effect such further execution.

Related aspects of the invention provide methods of software execution, e.g., as described above, wherein most-recently mentioned step (C) includes using the ML model executing on the AI engine to generate one or more action outputs to effect the further execution within any of (i) the first processing element and (ii) one or more other processing elements.

Further related aspects of the invention provide methods of software execution, e.g., as described above, including performing each of steps (A)-(C) on multiple processing elements of the multiprocessing element digital system.

Still further related aspects of the invention provide methods of software execution, e.g., as described above, including executing most-recently mentioned step (C) on each of the multiple processing elements using a said AI engine local to that processing element.

Yet still further related aspects of the invention provide methods of software execution, e.g., as described above, wherein most-recently mentioned step (C) includes generating the one or more action outputs to effect movement of data associated with one or more of the objects to the one or more other processing elements.

Still yet further related aspects of the invention provide methods of software execution, e.g., as described above, including performing a step of responding on a given processing element of the multiprocessing element digital system to one or more objects generated by another processing element of that system by further executing the software using any of data and instructions associated with a said object.

Yet still yet further related aspects of the invention provide methods of software execution, e.g., as described above, where the step of effecting further execution of the software on the given processing element includes effecting execution of one or more of the intercepted instructions or a modified form thereof.

Related aspects of the invention provide methods of software execution, e.g., as described above, wherein the multiple processing elements of the digital system access the objects using a common address space.

Further related aspects of the invention provide methods of software execution, e.g., as described above, wherein the ML model includes a decision transformer, reinforcement learning (RL) or other ML techniques and/or optimizations thereof.

Still further related aspects of the invention provide methods of software execution, e.g., as described above, wherein the ML model is trained with labeled data, unlabeled data and/or synthetic generated data representing execution of a set of one or more instructions other than those defining the software.

Yet still related aspects of the invention provide methods of software execution, e.g., as described above, wherein the ML model is trained during any of pre-runtime, runtime and update-training phases of execution of the software with any of labeled data and unlabeled data representing execution of the software.

Still yet further related aspects of the invention provide methods of software execution, e.g., as described above, wherein the ML model is trained using, as a cost function, any of (a) a period of time for effecting further execution of the software on one or more of the processing elements, (b) an amount of resources required for effecting further execution of the software on one or more of the processing elements, and (c) a number of processing elements required for effecting further execution of the software.

Still further related aspects of the invention provide methods of software execution, e.g., as described above, wherein most-recently mentioned step (C) includes logging inputs applied to the ML model and outputs generated thereby, and wherein the method further includes replaying the logged inputs and outputs to train the model during an update-training phase.

Yet still yet further related aspects of the invention provide methods of software execution, e.g., as described above, wherein most-recently mentioned step (C) includes generating the one or more action outputs to effect execution of one or more of the intercepted instructions or a modified form thereof on the one or more other processing elements of the multiprocessing element digital system.

Still further related aspects of the invention provide methods of software execution, e.g., as described above, including performing a step of responding on a given processing element of the multiprocessing element digital system to one or more objects generated by another processing element of that system by further executing the software on the given processing element using any of data and instructions associated with a said object.

Yet further related aspects of the invention provide methods of software execution, e.g., as described above, wherein most-recently mentioned step (C) includes generating the one or more action outputs to effect execution of one or more of the intercepted instructions or a modified form thereof on the first processing element.

Still yet further related aspects of the invention provide methods of software execution, e.g., as described above, wherein most-recently mentioned step (C) includes (i) generating the one or more objects to effect execution of one or more of the intercepted instructions or a modified form thereof on the one or more other processing elements of the digital system, and (ii) generating the one or more action outputs to effect execution of one or more of the intercepted instructions or a modified form thereof on the first processing element.

In other aspects, the invention provides methods of executing software that include, alone or in combination with the methods above, the steps of (A) executing a software application on a first processing element of a digital system to process a set of data, where the digital system includes multiple processing elements, including the first processing element, that are coupled by communications media; (B) any of detecting and intercepting (collectively, “intercepting”) one or more instructions executed by the first processing element during and as a result of its execution of the software application; (C) applying a representation of one or more of the intercepted instructions to an artificial intelligence (AI) engine local to the first processing element to generate, using a machine learning (ML) model executing on that AI engine, one or more action outputs of the ML model including commands to effect further execution of the software application on multiple processing elements of the digital system; (D) generating based on those action outputs one or more objects that (a) are associated with instructions making up at least the portion of the software application upon which such further execution is to be effected, and (b) are associated with at least a subset of the set of data, in an address space common to the multiple processing elements, to be processed by those associated instructions; (E) making available one or more of the action outputs and one or more of the objects to the multiple processing elements for processing thereby; and (F) performing each of steps (A)-(E) on each of the one or more other processing elements of the digital system using an AI engine local to that processing element.

In other aspects, the invention provides methods of executing software that include, alone or in combination with the methods above, the steps of (A) executing a software application on a plurality of processing elements of a digital system to process a set of data; (B) any of detecting and intercepting (collectively, “intercepting”) on each of the plurality of processing elements one or more instructions executed by that processing element during and as a result of that processing element's execution of the software application; (C) with each of the plurality of processing elements, applying a representation of one or more of the instructions intercepted during execution of the software application on that processing element to an artificial intelligence (AI) engine local to that processing element to generate, using a machine learning (ML) model executing on that AI engine, one or more action outputs of the ML model including commands to effect further execution of the software application on (i) that processing element and (ii) one or more others of the plurality of processing elements of the system; (D) with at least one of the plurality of processing elements, generating based on those action outputs one or more objects that (a) are associated with instructions making up at least the portion of the software application upon which such further execution is to be effected, and (b) are associated with data in an address space common to the multiple processing elements to be processed by those associated instructions; and (E) making available one or more of the action outputs and one or more of the objects to the multiple processing elements for processing thereby.

Further related aspects of the invention provide methods of software execution, e.g., as described above, including performing a step of responding on a given processing element of the multiprocessing element digital system to one or more objects generated by another processing element of that system by effecting further execution of the software application on the given processing element using any of data and instructions associated with a said object.

Still further related aspects of the invention provide methods of software execution, e.g., as described above, where the step of effecting further execution of the software application on the given processing element includes effecting execution of one or more of the intercepted instructions or a modified form thereof.

Yet still further related aspects of the invention provide methods of software execution, e.g., as described above, wherein the ML model of the AI engine of each of the processing elements of the system includes a decision transformer, reinforcement learning (RL) or other ML techniques and/or optimizations thereof.

Still yet further related aspects of the invention provide methods of software execution, e.g., as described above, wherein the ML model of the AI engine of each of the processing elements of the system is trained with labeled data, unlabeled data and/or synthetic generated data representing execution of a set of one or more instructions other than those defining the software.

Yet still yet further related aspects of the invention provide methods of software execution, e.g., as described above, wherein the ML model of the AI engine of each of the processing elements of the system is trained with labeled data, unlabeled data and/or synthetic generated data representing execution of the software application.

Related aspects of the invention provide methods of software execution, e.g., as described above, wherein the ML model of the AI engine of each of the processing elements of the system is trained using, as a cost function, any of (a) a period of time for effecting further execution of the software application on one or more of the processing elements of the system, (b) an amount of resources required for effecting further execution of the software application in response to one or more of the action outputs, or objects based thereon, on one or more of the processing elements of the system, and (c) a number of processing elements required for effecting further execution of the software application in response to one or more of the action outputs, or objects based thereon.

The invention provides in other aspects methods of executing software on a digital system with multiple processing elements that are coupled for communications, including, alone or in combination with the methods above, the steps of (A) executing software on a processing element of a digital system that includes multiple processing elements; (B) with that processing element, applying a representation of one or more instructions of the executing software to an artificial intelligence (AI) engine executing on that processing element to generate one or more first action outputs including commands to effect further execution of the software on multiple processing elements of the digital system; and, (C) with another processing element of the digital system, generating with an AI engine executing on that other processing element one or more further action outputs including commands to effect the further execution of the software.

Further related aspects of the invention provide methods of software execution, e.g., as described above, including performing most-recently mentioned step (C) on multiple processing elements of the multiprocessing element digital system.

Still further related aspects of the invention provide methods of software execution, e.g., as described above, including performing each of steps (A)-(C) on multiple processing elements of the multiprocessing element digital system.

Yet still further related aspects of the invention provide methods of software execution, e.g., as described above, wherein most-recently mentioned step (B) includes making one or more of the first action outputs or constructs based thereon available to the other processing elements.

Still yet further related aspects of the invention provide methods of software execution, e.g., as described above, wherein a said construct includes one or more objects that (i) are associated with instructions making up at least a portion of the software upon which such further execution is to be effected, and (ii) are associated with at least a subset of the set of data, in an address space common to the multiple processing elements, to be processed by those associated instructions.

Yet still yet further related aspects of the invention provide methods of software execution, e.g., as described above, including making the one or more first action outputs or constructs based thereon available to other processing elements by way of communications media.

Further related aspects of the invention provide methods of software execution, e.g., as described above, wherein each of the AI engines includes a respective learning (ML) model that generates action outputs.

Still further related aspects of the invention provide methods of software execution, e.g., as described above, wherein the software includes one or more software applications.

Yet still further related aspects of the invention provide methods of software execution, e.g., as described above, wherein most-recently mentioned step (B) includes making action outputs available to the one or more other processing elements via communications media.

Other aspects of the invention provide a method of executing software on a digital system with multiple processing elements that are coupled for communications, including, alone or in combination with the methods above, the steps of (A) executing software on a processing element of a digital system that includes multiple processing elements; (B) with that processing element, applying a representation of one or more instructions of the executing software to an artificial intelligence (AI) engine executing on that processing element to generate one or more first action outputs including commands to effect further execution of the software on multiple processing elements of the digital system; and (C) with another processing element of the digital system, effecting that further execution of the software by executing at least a portion thereof based on generation of the one or more first action outputs.

Yet still yet further related aspects of the invention provide methods of software execution, e.g., as described above, including performing most-recently mentioned step (C) on multiple processing elements of the multiprocessing element digital system.

Further related aspects of the invention provide methods of software execution, e.g., as described above, including the step of (D) with that other processing element, applying a representation of one or more instructions of the software executing on that other processing element to an artificial intelligence (AI) engine executing on that other processing element to generate one or more further action outputs including commands to effect further execution of the software on multiple processing elements of the digital system,

Still further related aspects of the invention provide methods of software execution, e.g., as described above, including performing steps (C)-(D) on multiple processing elements of the multiprocessing element digital system.

Yet still further related aspects of the invention provide methods of software execution, e.g., as described above, wherein most-recently mentioned step (B) includes making one or more of the first action outputs or constructs based thereon available to other processing elements.

Still yet further related aspects of the invention provide methods of software execution, e.g., as described above, wherein a said construct includes one or more objects that (i) are associated with instructions making up at least a portion of the software upon which such further execution is to be effected, and (ii) are associated with at least a subset of the set of data, in an address space common to the multiple processing elements, to be processed by those associated instructions.

Yet still yet further related aspects of the invention provide methods of software execution, e.g., as described above, including making the one or more first action outputs or constructs based thereon available to the other processing element by way of communications media.

Further related aspects of the invention provide methods of software execution, e.g., as described above, wherein each of the AI engines includes a respective learning (ML) model that generates action outputs.

Still further related aspects of the invention provide methods of software execution, e.g., as described above, wherein the software includes one or more software applications.

Yet still further related aspects of the invention provide methods of software execution, e.g., as described above, wherein most-recently mentioned step (B) includes making action outputs available to the one or more other processing elements via communications media.

Still yet further related aspects of the invention provide methods of software execution, e.g., as described above, where each said processing element comprises any of (i) one or more processor cores, including at least one central processing unit (CPU) core, graphics processing unit (GPU) core and/or specialized processing unit (SPU) core, (ii) a virtualization container executing on one or more processor cores, (iii) a virtual machine executing on such cores, and/or (iv) a combination of the foregoing.

Yet still yet further related aspects of the invention provide methods of software execution, e.g., as described above, where each said CPU, GPU and/or SPU (i) accesses local memory and I/O logic of the respective processing element by way of a shared local bus or backplane, and/or (ii) collectively, execute a single instance of an operating system.

### Communication Protocol for Distributed Processing of Software Applications

The foregoing objects are also attained by the invention, which provides in some aspects a method for use alone or in combination with the methods above of executing software on a digital processor system having at least one processing element that is coupled to communications media, the method includes, alone or in combination with the methods above, the steps of (A) transmitting on the communications media a plurality of block-type objects, each associated with instructions making up software to be executed; (B) transmitting on the communications media a plurality of data-type objects, each associated with data to be processed; (C) transmitting on the communications media a plurality of task-type objects, each associated with a block object and with one or more data objects associated with data to be processed by the software associated with that block object; (D) transmitting on the communications media a plurality of thread-type objects, each associated with a said task-type object and each defining a processing environment in which the data associated with the one or more data-type objects associated with that task-type object are to be processed by the software associated with the block-type object associated with that task-type object.

Related aspects of the invention provide methods, e.g., as described above, including the steps of (A) instantiating and executing on a said processing element a thread utilizing the processing environment defined in a said thread-type object; and (B) executing in that thread the software associated with the block-type object associated with the task-type object associated with that thread-type object to effect processing of the data associated with one or more of the data-type objects associated with that task-type object.

Further related aspects of the invention provide methods, e.g., as described above, wherein one or more of the task-type objects is defined to merge results from processing effected by one or more other task-type objects.

Still further related aspects of the invention provide methods, e.g., as described above, wherein one or more of the task-type objects are defined as split from another task-type object.

Yet still further related aspects of the invention provide methods, e.g., as described above, wherein one or more of the task-type objects defines an order and/or manner in which data associated with the one or more data-type objects associated with that task-type object are to be processed by the software associated with the block-type object associated with that task-type object.

Still yet further related aspects of the invention provide methods, e.g., as described above, wherein the order and/or manner of processing include any of row major, column major, independent, tensor and single-update, among others.

Other aspects of the invention provide a method of executing software on a digital processor system having a plurality of processing elements, the method including, alone or in combination with the methods above, the steps of (A) making available to a plurality of processing elements one or more block-type objects, each associated with instructions making up software upon which execution is to be effected; (B) making available to the plurality of processing elements one or more data-type objects, each associated with data to be processed; (C) making available to the plurality of processing elements one or more task-type objects that each identify a said block object and one or more data objects associated with data to be processed by the software associated with that block object; (D) making available to the plurality of processing elements one or more objects (each, a “thread object”) defining a processing environment in which the data associated with the one or more data-type objects associated with a said task-type object is to be processed by the software associated with the block-type object associated with that task-type object.

Related aspects of the invention provide methods, e.g., as described above, including the steps of (A) receiving a task-type object on a said processing element; (B) determining with that processing element whether it has resources to process with the software associated with the block-type object associated with that task-type object the data associated with the one or more data-type objects associated with that task-type object, and (C) responding to a positive such determination by (i) instantiating and executing on that processing element a thread utilizing the processing thread environment defined in a thread-type object associated with the received task-type object; and (ii) executing on that processing element the software associated with the block-type object associated with that task-type object to effect processing of the data associated with one or more of the data-type objects associated with that same task-type object.

Further related aspects of the invention provide methods, e.g., as described above, wherein one or more of the task-type objects is defined to merge results from processing effected by one or more other task-type objects.

Still further related aspects of the invention provide methods, e.g., as described above, wherein one or more of the task-type objects are defined as split from another task-type object.

Yet still further related aspects of the invention provide methods, e.g., as described above, wherein one or more of the task-type objects defines an order and/or manner in which data associated with the one or more data-type objects associated with that task object are to be processed by the software associated with the block-type object associated with that task-type object.

Still yet still further related aspects of the invention provide methods, e.g., as described above, wherein the order and/or manner of processing include any of row major, column major, independent, tensor and single-update, among others.

Other aspects of the invention provide a method of parallelizing execution of software on a digital processor system having a plurality of processing elements, the method including, alone or in combination with the methods above, the steps of (A) executing software on a first processing element to process data; (B) parallelizing at least further execution of the software over a plurality of the processing elements by generating and making available to one or more processing elements other than the first processing element (“other processing elements”): (i) a block-type object associated with instructions making up at least the portion of the software upon which such further execution is to be effected; (ii) one or more data-type objects, each associated with at least the subset of the data to be processed by those associated instructions; (iii) one or more task-type objects identifying a block-type object and identifying one or more data-type objects associated with data to be processed by the software associated with that block object; (iv) one or more objects (each, a “thread object”) defining a processing environment in which the data associated with the one or more data objects associated with a said task object are to be processed by the software associated with the block-type object associated with that task-type object.

Related aspects of the invention provide methods, e.g., as described above, including the steps of (A) instantiating and executing on a second processing element a thread utilizing the processing thread environment defined in a selected thread-type object; and (B) executing the software associated with the block-type object associated with that task-type object to effect processing of the data associated with one or more of the data-type objects associated with that same task-type object.

Further related aspects of the invention provide methods, e.g., as described above, wherein one or more of the task-type objects is defined to merge results from processing effected by one or more other task-type objects.

Still further related aspects of the invention provide methods, e.g., as described above, wherein one or more of the task-type objects are defined as split from another task-type object.

Yet still further related aspects of the invention provide methods, e.g., as described above, wherein one or more of the task-type objects defines an order and/or manner in which data associated with the one or more data-type objects associated with that task-type object are to be processed by the software associated with the block-type object associated with that task-type object.

Still yet further related aspects of the invention provide methods, e.g., as described above, wherein the order and/or manner of processing include any of row major, column major, independent, tensor and single-update, among others.

Further aspects of the invention provide methods, e.g., as described above, where each said processing element comprises any of (i) one or more processor cores, including at least one central processing unit (CPU) core, graphics processing unit (GPU) core and/or specialized processing unit (SPU) core, (ii) a virtualization container executing on one or more processor cores, (iii) a virtual machine executing on such cores, and/or (iv) a combination of the foregoing.

Still further related aspects of the invention provide methods, e.g., as described above, where each said CPU, GPU and/or SPU (i) accesses local memory and I/O logic of the respective processing element by way of a shared local bus or backplane, and/or (ii) collectively, execute a single instance of an operating system.

### Coordinated Parallelization and Execution of Software Applications

The foregoing objects are also attained by the invention, which provides in some aspects methods, for use alone or in combination with the methods above, of executing software on a digital system with multiple processing elements by executing one or more software applications on each of m given ones of n processing elements of a digital system, where m and n are integers greater than or equal to two and where n is greater than or equal to m. Each of the m given processing elements performs steps of (i) at least beginning execution of a given software application; (ii) determining at least a number of resources to be used for further execution of that given software application, where that determination is a function of availability of resources on that given processing element and on at least one other processing element of the digital system; (iii) determining an availability of resources on that given processing element for execution of software applications other than that given software application, where that determination takes into account the determination of most-recently mentioned step (ii); (iv) effecting further execution of that given software application on multiple processing elements of the digital system; and (v) making a result of the determination of most-recently mentioned step (iii) available to others of the m given processing elements.

Further aspects of the invention provide methods of executing software, e.g., as described above, wherein m is two and wherein steps (i)-(v) include performing the following steps with a first of the given processing elements: at least beginning execution of a first given software application; determining at least a number of resources to be used for further execution of that first given software application, where that determination is a function of availability of resources on that first given processing element and on at least one other processing element of the digital system; determining an availability of resources on that first given processing element for execution of software applications other than that first given software application, where that determination takes into account the determination of the aforesaid prior step; effecting further execution of that given software application on multiple processing elements of the digital system; and making a result of the last aforesaid determination available to at least a second of the given processing elements. The method further includes performing the following steps with the second given processing element: at least beginning execution of a second given software application; determining at least a number of resources to be used for further execution of that second given software application, where that determination is a function of availability of resources on that second given processing element and on at least one other processing element of the digital system; determining an availability of resources on that second given processing element for execution of software applications other than that second given application, where that determination takes into account the determination of the prior aforesaid step; effecting further execution of that given software application on multiple processing elements of the digital system; making a result of the last aforesaid determination available to at least the first given processing element.

Still further aspects of the invention provide methods of software execution, e.g., as described above, where m and n are greater than 100.

Yet still further aspects of the invention provide methods of software execution, e.g., as described above, where m and n are greater than 1000.

Still yet further aspects of the invention provide methods of software execution, e.g., as described above, where m and n are greater than 10,000.

Yet still yet further aspects of the invention provide methods of software execution, e.g., as described above, wherein the aforesaid determinations are made available to others of the m given processing elements via common shared memory.

In still yet further aspects of the invention, a method as described above includes transmitting to at least a said processing element on which the further execution is being effected (a) instructions making up at least a portion of the software application that is to be further executed, and (b) data to be processed thereby. In related aspects of the invention, that method can include determining, with the given processing element, (i) at least a number of threads to be processed to further execution of the given software application, and/or at least a number of resources to be used to parallelize execution of the given software application on multiple processing elements of the digital system.

Other aspects of the invention provide methods of software execution, e.g., as described above that include effecting parallelized execution of the given software application on multiple processing elements of the digital system.

Yet still other aspects of the invention provide methods of software execution, e.g., as described above, where the determination of most-recently mentioned step (ii) is a function of availability of resources on the given processing element and on the other processing elements of the digital system and/or where most-recently mentioned step (iv) includes effecting further execution of the given software application on the given processing element and on at least one other targeted processing elements of the digital system. In related aspects, the invention provides such a method in which most-recently mentioned step (iv) includes transmitting to the targeted processing element (a) instructions making up at least a portion of the software application that is to be further executed, and (b) data to be processed thereby.

Still further aspects of the invention provide methods, e.g., as described above, wherein most-recently mentioned step (ii) includes determining the number of resources to be used as a function of at least one of a memory capacity and availability of the given processing element, a thread capacity and availability of each processor type (e.g., CPU, GPU, SPU, etc.) in that given processing element, a memory capacity and availability of the at least one other processing element of the digital system, and a thread capacity and availability of each processor type in that at least one other processing element of the digital system, where “availability” refers to current and future.

Other aspects of the invention provide a method of executing software on a digital system with multiple processing elements, including the steps of (A) executing one or more software applications on each of m given ones of n processing elements of a digital system, where m and n are integers greater than or equal to two and where n is greater than or equal to m; and (B) with each of the given processing elements, performing steps of (i) with that given processing element, at least beginning execution of a given software application, (ii) with that given processing element, determining a strategy for further execution of that given software application on multiple processing elements of the digital system and generating commands to effect that strategy, (iii) with that given processing element, determining at least a number of resources to be used for further execution of that given software application, where that determination is a function of availability of resources on that given processing element and on at least the others of the m given processing element of the digital system, (iv) with that given processing element, determining an availability of resources on that given processing element for execution of software applications other than that given software application, where the determination of step (iv) takes into account the determination of step (iii), (v) with that given processing element, making the commands directly or indirectly available to multiple processing elements of the digital system in order to effect further execution of that given software application on multiple processing elements in accord with the strategy, where those multiple processing elements include at least one other of the m given processing elements, and (vi) with that given processing element, making a result of the determination of step (iv) available to others of the m given processing elements.

Related aspects of the invention provide methods, e.g., as described above, wherein most-recently mentioned step (ii) includes determining the strategy to take into account resource capacity and availability, both current and expected future availability of the given processing element and the others of the m given processing elements, including generating said commands to effect execution of a given software application on a processing element having suitable resources therefor.

Further related aspects of the invention provide methods, e.g., as described above, wherein most-recently mentioned step (ii) includes determining the strategy to localize instruction and/or data in connection with execution of the given software application on the multiple processing elements, including generating said commands to effect movement of related instructions and/or data used in execution of one or more software applications to the same or nearby processing elements.

Still further related aspects of the invention provide methods, e.g., as described above, wherein most-recently mentioned step (ii) includes determining the strategy to effect checkpointing of one or more processing threads during execution of the given software application on the multiple processing elements.

Yet still further related aspects of the invention provide methods, e.g., as described above, wherein most-recently mentioned step (ii) includes determining the strategy to effect load balancing during execution of software applications on the multiple processing elements.

Still further related aspects of the invention provide methods, e.g., as described above, wherein most-recently mentioned step (ii) includes determining the strategy to effect generation of commands for requesting that, when available, tasks and/or data be pushed to a given processing element.

Further aspects of the invention provide methods, e.g., as described above, where each said processing element comprises any of (i) one or more processor cores, including at least one central processing unit (CPU) core, graphics processing unit (GPU) core and/or specialized processing unit (SPU) core, (ii) a virtualization container executing on one or more processor cores, (iii) a virtual machine executing on such cores, and/or (iv) a combination of the foregoing.

Still further aspects of the invention provide methods, e.g., as described above, where each said CPU, GPU and/or SPU (i) accesses local memory and I/O logic of the respective processing element by way of a shared local bus or backplane, and/or (ii) collectively, execute a single instance of an operating system.

Yet still further aspects of the invention provide methods, e.g., as described above, in which one or more of the aforesaid processing elements includes (i) a virtualization container (or, simply, as referred to herein, a “container”) executing on one or more processor cores, (ii) a virtual machine executing on such cores, and/or (iii) a combination of the foregoing.

Still yet further aspects of the invention provide methods, e.g., as described above, in which each of the aforesaid processors is any of a processor core or a processing element.

These and other aspects of the invention are evident in the discussion that follows and in the drawings.

### BRIEF DESCRIPTION OF THE DRAWINGS

A more complete understanding of the invention may be attained by reference to the drawings, in which:

FIGS. 1A-1D depict systems according to practices of the invention and of the type in connection with which the invention is practiced;

FIG. 2 depicts the architecture and method of operation of a multi-processing element (or “multi-nodal”) system according to one practice of the invention;

FIG. 3 depicts a method of parallelizing a software application according to a further practice of the invention;

FIG. 4 depicts relationships among objects of the type generated and used in practice of the invention;

FIGS. 5A-5D depict task objects of the type utilized in the embodiments of FIGS. 2 and 3;

FIG. 6 depicts how task objects can be used to effect parallel execution of application software (or a portion thereof) in a system according to the invention;

FIG. 7 is a flow diagram depicting interaction of adapters, a distributed object store subsystem and an AI engine (and, more particularly, an ML model) in training, runtime and training-update stages of operation of a system according to the invention;

FIG. 8 depicts an architecture for parallelization of a software application in accord with the prior art;

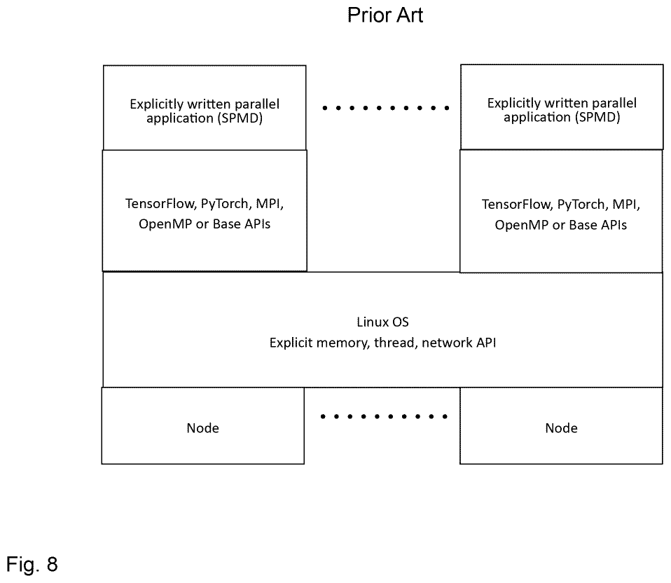

FIG. 9 depicts a system according to the invention;

FIG. 10 depicts per-app dynamic machine-learning based parallelized application execution in a system according to the invention;

FIG. 11 depicts a multi-nodal system for parallelized software execution according to the invention;

FIG. 12 depicts a further multi-nodal system for parallelized software execution according to the invention;

FIG. 13 depicts a node in a multi-nodal system for parallelized software execution according to the invention;

FIG. 14 depicts adapter and runtime subsystems in a system according to the invention;

FIG. 15 depicts distributed directory, coherence and transport in a system according to the invention;

FIG. 16 depicts a distributed object engine and machine learning interface in a system according to the invention;

FIG. 17 depicts a remote distributed object meta-data directory in a system according to the invention;

FIG. 18 depicts remote operation and coherence flow in a system according to the invention;

FIG. 19 depicts object movement in a system for parallelized software execution according to the invention;

FIG. 20 depicts a local machine learning subsystem in a system according to the invention;

FIG. 21 depicts app-initiated generic operation flow in a system according to the invention;

FIG. 22 depicts an application (“app”) object hit in a system according to the invention;

FIG. 23 depicts an object miss with optional additional actions in a system according to the invention;

FIG. 24 depicts an app hit with additional actions in a system according to the invention;

FIG. 25 depicts an application thread start remote in a system according to the invention;

FIG. 26 depicts remote-initiated generic operation flow in a system according to the invention; and

FIG. 27 depicts learned dynamic parallel program behavior on a per-node basis in a system according to the invention.

### DETAILED DESCRIPTION OF THE ILLUSTRATED EMBODIMENT

### System Architecture

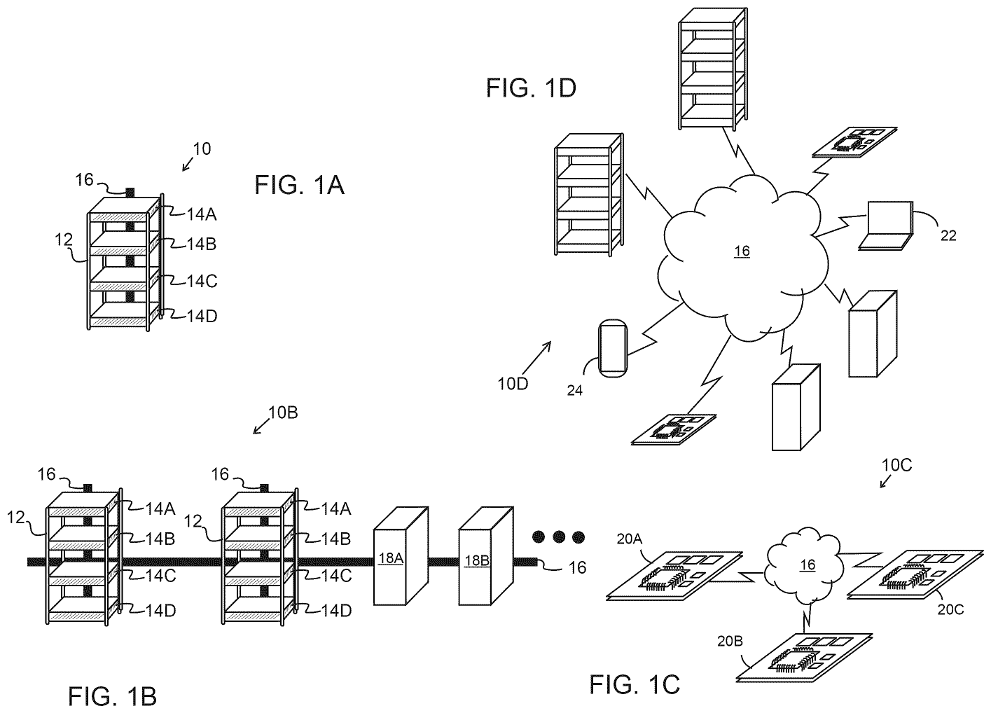

FIGS. 1A-1D depict multi-nodal systems 10, 10B-10D, respectively, according to practices of the invention and of the type in connection with which the invention is practiced. Generally speaking, each of those systems includes a plurality of processing elements (or “nodes”) that are coupled for communications, e.g., via a network. In the discussion that follows and throughout this document, the terms “processing element” and “node” are used interchangeably, unless otherwise evident from context.

A processing element used in the drawing and, more generally, in practice of the invention can include the following components:
one or more central processing units (CPUs), graphics processing units (GPUs) and/or specialized processing units (SPUs), at least one of which is capable of executing an operating system (OS). Thus, a processing element may include a single CPU, GPU or SPU or it may include a homogenous or heterogenous collection of multiple such units, all by way of example;
local memory such as, for example RAM and cache. As used herein, “local memory” means all memory accessible through execution of a processor memory reference instruction by any of the CPUs, GPUs and/or SPUs of the respective processing element, including, memory accessible over PCIe or other I/O bus, by way of non-limiting example;
I/O logic supporting communications over a network or otherwise with other processing elements and external functionalities, such as, for example, solid state (or other) drives and other peripherals;
a local bus or backplane supporting communications among and between the CPU(s), GPU(s) and/or SPU(s) of the respective processing element, its local memory and its I/O logic;
where the components of the respective processing element cooperate with one another to execute software applications in the conventional manner known in the art as adapted in accord with the teachings hereof; and
where, the CPUs, GPUs and/or SPUs that make up the respective processing element (i) share access to local memory and I/O logic of that processing element by way of its local bus or backplane, and/or (ii) collectively, execute a single instance of an operating system. In some embodiments, the processing elements meet both of those conditions (i) and (ii), while in other embodiments they may meet only one of those conditions.

In practice, the central processing units, if any, of each processing element with which the invention is practiced typically comprise multiple CPUs that are implemented as “cores” disposed on the same silicon substrate and/or within the same chipset and that share access to the local memory and I/O logic of that processing element by way of the bus or backplane local to that processing element per convention in the art as adapted in accord with the teachings hereof. This is likewise true of the graphics processing units and specialized processing units, if any, within each processing element: they, too, typically comprise multiple GPUs or SPUs, as the case may be, implemented as cores disposed on or in a common respective substrate or chipset and share access to the other processor cores, local memory, and local I/O logic of that processing element via the local bus and/or backplane of that processing element, again, per convention in the art as adapted in accord with the teachings hereof. Of course, it will be appreciated that processing elements used in practice of the invention may vary in the foregoing regards: for example, a single substrate or chipset may include processor cores of multiple varieties, e.g., CPU, GPU and/or SPU. It will also be appreciated that the invention can be practiced, instead or in addition, with processing elements that each comprise single-core CPUs, single-core GPUs and/or single-core SPUs. And, while the CPU, GPU and/or SPU cores of some embodiments may communicate with one another through buses or backplanes, in other embodiments, those communications may take place through shared memory or otherwise, all as per convention in the art as adapted in accord with the teachings hereof. For the sake of brevity, in the discussion that follows, regardless of type, the CPU(s), GPU(s) and/or SPU(s) of a node are generically referred to as the “CPU” or “processor” (e.g., “processor 30”) of the respective node, except where otherwise evident from context.

Instead of, or in addition to, the above, a processing element used in practice of the invention can be
a virtualization container (or, simply, as referred to herein, a “container”) executing on one or more processor cores, whether that container is instantiated by virtualization software such as that commercially available from Docker, Kubernetes, or otherwise,
a virtual machine executing on such cores, whether instantiated under such commercially available software as VMware, KVM, or otherwise,
a combination of virtualization container(s) and virtual machine(s), as defined above.

Turning back to FIGS. 1A-1D, as evident in the drawing, processing elements of the illustrated embodiments may take any variety of form factors and may be implemented, for example, in digital data devices of the type commercially available in the marketplace or otherwise, all as adapted in accord with the teachings hereof. Examples of such digital data devices include mainframe computers, minicomputers, workstations, embedded systems, systems on a chip (SOCs), personal computers, and smart phones, to name a few. Moreover, systems according to the invention and/or in connection with which the invention is practiced may include any number, selection, mix and/or connectivity of such processing elements, with FIGS. 1A-1D being illustrative of only a few examples.

Referring to FIG. 1A, there is provided a simplified illustration of a system 10 that includes a set of processing elements 14A-14D, here, in the form of rack-mount computers (e.g., servers), disposed in a rack 12 and coupled for communication via network 16. Illustrated system 10B (FIG. 1B) includes two such sets of rack-mounted processing elements and two stand-alone processing elements 18A, 18B, here, in the form of workstations, all coupled for communications via network 16. Illustrated system 10C (FIG. 1C) includes three processing elements 20A-20C, here, in the form of SoC's (systems on a chip) coupled for communications via network 16. Illustrated system 10D (FIG. 1D) includes two sets of rack-mount processing elements of the type shown in FIG. 1A, two stand-alone workstations of the type shown in FIG. 1B, two SoCs of the type shown and FIG. 1C and two personal computing devices, e.g., a laptop computer 22 and a mobile phone 24, all coupled via network 16 of the type defined below, as shown.

As used in FIGS. 1A-1D and elsewhere herein, network 16 may comprise any digital communications media or combination thereof (whether physical, virtual, shared memory-based, direct, indirect, peer-to-peer and/or otherwise) available in the marketplace or otherwise known in the art, wired, wireless or otherwise, suitable for use in supporting communications between nodes operating as described herein, all as adapted in accord with the teachings hereof. In the discussion that follows, network 16 is alternatively referred to as a “communications medium” or “communications media.”

### Processing Elements-Architecture

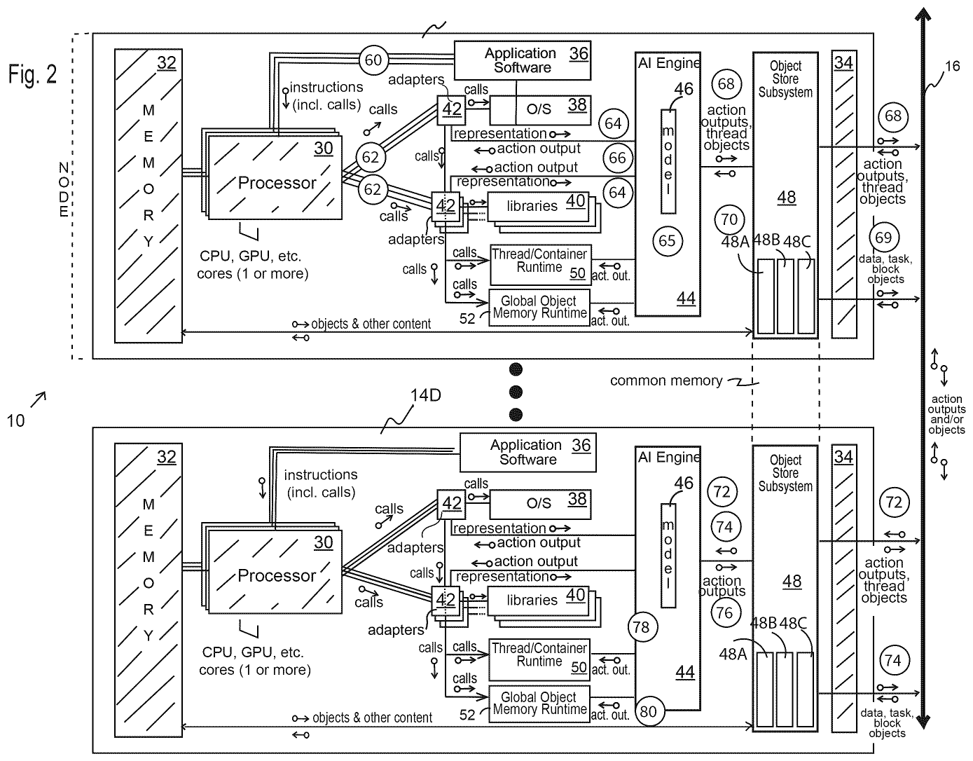

FIG. 2 depicts the architecture and method of operation of a multi-nodal digital system according to one practice of the invention. The drawing and discussion that follows are with respect to system 10 of FIG. 1A and, more particularly, with respect to processing elements (or nodes) 14A and 14D of system 10, though, the teachings provided are equally applicable to the other processing elements of system 10 and to other multi-nodal digital systems, whether illustrated in FIGS. 1B-1D or otherwise, and their substituent processing elements.

Without detracting from the generality of the invention, in the embodiment of FIG. 2 and discussed below, the processing elements 14A, 14D are (i) each of the variety characterized by having one or more CPU(s) and zero, one or more GPU(s) and/or SPUs that collectively execute a single instance of an operating system (here, by way of non-limiting example, on processor 30), and (ii) coupled for communications with one another (and with other processing elements of the system 10) by a network 16 that comprises a PCIx bus, LAN (wireless, wired or otherwise), all of the conventional type known in the art as adapted in accord with the teachings hereof. The teachings that follow with respect thereto are equally applicable to other embodiments of the invention, e.g., utilizing processing elements made up of different mixes of CPUs, GPUs, SPUs, containers, virtual machines and/or combinations thereof, consistent with the discussion above, and coupled by additional or different communications media, also consistent with the discussion above.

Turning to FIG. 2, nodes 14A and 14D of system 10 include hardware and software components. The hardware components, which are shown with hatching, include a processor 30, local memory 32 (where the term “local memory” is used in the manner defined above) and I/O logic 34. Each of these components is of the type and operates in the manner of like-named components available in the marketplace or otherwise known in the art, as adapted in accord with the teachings hereof. The bus or backplane (not shown) of each node 14A, 14D supports interconnectivity between the components of the respective node in the conventional manner known in the art as adapted in accordance with the teachings hereof.

As noted above, GPUs or SPUs discussed above optionally provided in the nodes 14A, 14D are of the type available in the marketplace or otherwise known in the art and, as also previously noted, operate under control of the associated processor 30 in the conventional manner known in the art as adapted in accord with the teachings hereof. (As also noted above, however, processing elements used in systems according to some practices of the invention do not require CPUs and may, instead, comprise only GPU(s) and/or SPU(s), one of which executes an instance of the OS on behalf of that processing element.) Here and in the discussion which follows, and unless otherwise evident from context, references to the processor 30 implicitly include (i) its attendant CPU cores, (ii) any GPUs (and their attendant GPU cores) and/or SPUs (and their attendant SPU cores) in the respective node. It is within the ken of those skilled in the art to apply the teachings that follow with respect to nodes 14A-14D to other embodiments of the invention, e.g., utilizing processing elements made up of different mixes of CPUs, GPUs, SPUs, containers, virtual machines and/or combinations thereof.

The nodes 14A, 14D execute the illustrated software components (shown without hatching) in the conventional manner known in the art as adapted in accord with the teachings hereof. Although depicted as separate from the hardware components, it will be appreciated that in practice the software components are typically maintained in memory 32 prior to execution by the processor 30 and/or, where present, the GPUs (or SPUs) of each node—and, depending on the actual or expected timing of its execution by the processor 30, in various ones of the memory, cache and/or other components that make up local memory 32, all as per convention in the art as adapted in accord with the teachings hereof.

Software components executed by each node 14A, 14D can include the following, by way of non-limiting example, all of which are shared and accessible for execution by the processor cores (whether CPUs, GPUs, SPUs or otherwise) included in the node 14A, per convention in the art as adapted in accord with the teachings hereof:
Application software 36 for performing application-specific tasks (e.g., digital Twins across a broad range of scientific, medical, business and manufacturing including integral AI/ML, standalone AI/ML, to name a few). Software 36 of the illustrated embodiment is conventional application software of the type known in the art as adapted in accord with the teachings hereof. Illustrated application software 36 may, alternatively, be a portion of such conventional application software—as might be the case, for instance, for a node 14A-14D that is processing a portion of an entire software application in response to a parallelization request from another node. Parallelization of application software 36 (or portions thereof) as discussed throughout this application includes parallelization of functions and/or other software (whether contained in software libraries 40, operating system 38 or otherwise) invoked by or as a consequence of execution of such application software 36 (or portion thereof).
Operating system (OS) 38 for managing computer hardware and software resources in the conventional manner known in the art as adapted in accord with the teachings hereof. OS software is typically neither user-nor software application-specific but, rather, is supplied with or otherwise installed for execution on digital data processor hardware (e.g., nodes 14A, 14D) to allow it to execute software applications and to provide fundamental computer services (memory and file management, peripheral device allocation, network communications, and so forth), all per convention in the art as adapted in accord with the teachings hereof.
Software libraries 40 provide utilities commonly requested by software applications and invoked by them (or other library utilities) through “calls” or other computer programming instructions. Software libraries are typically developed, maintained and/or distributed separately from the software applications that use them. Software 40 of the illustrated embodiment represents conventional software libraries of the type known in the art, all as adapted in accord with the teachings hereof. In the discussion that follows and in the claims, references to calls to a “software library,” “library” and the like, and/or to calls to functions in such a library, include calls to functions in the OS 38 (whether directly or indirectly, e.g., via a call to a software library), unless otherwise evident from context.

Illustrated system 10, alternatively referred to herein as the “transparent distributed application framework” (or TDAF), enables application software 36 of node 14A to be distributed and executed across multiple cores within the node 14A and/or across multiple other nodes 14B-14D (and their respective processors and/or cores). That distribution and execution takes into account efficiency, problem size, parallelism and performance by dynamically managing application data and parallel processing by leveraging networked computer, memory and storage resources. The parallelism model is APAD, Adaptive Processing Adaptive Data, meaning units of computation and data can vary spatially and temporally—or, put another way, that the model can be applied to dynamic, heterogenous multi-nodal digital data systems, as well as to static, homogeneous ones.

To that end, software executed by each node 14A, 14D additionally includes the following, all of which are shared and accessible for execution by the processors included in that respective node, whether CPU, GPU, SPU or otherwise, per convention in the art as adapted in accord with the teachings hereof:
Adapters (or “hooks”) 42 associated with software libraries and specific functions therein (as well, as noted above, with such functions in OS 38) to detect, if not intercept, calls to those libraries/functions, as well as messages and events directed to them or emanating from them. In the illustrated embodiment, adapters/hooks 42 are implemented as wrappers, though, in other embodiments their functionality can be implemented through modification of the software libraries with which they are associated or otherwise, as is within the ken of those skilled in the art in view of the teachings hereof. The adapters 42 are referred to collectively, herein, as an “application environment adapter subsystem,” or the like. As those skilled in the art will appreciate in view of the discussion below, specialized adapters for specific types of language libraries including, for example, OpenMPI, OpenMP, CUDA, TensorFlow, PyTorch, etc., as well as common runtime libraries for memory allocation and threading, enable efficient conversion into a common pseudocode interface between the adapter and the ML subsystem discussed below.
AI engine 44 and its attendant machine learning model 46. In the illustrated embodiment, these are implemented as a runtime framework (or subsystem) executing on each of the plurality of the nodes, e.g., 14A, 14D, that make up system 10. In other embodiments, the functionality of one or more of software 44-48 may be implemented in software libraries or otherwise, as is within the ken of those skilled in the art in view of the teachings hereof.
Thread/container runtime 50. In the illustrated embodiment, this is implemented in runtime libraries, though, in other embodiments its functionality can be implemented through modification or supplementation of existing libraries, or otherwise, all as is within the ken of those skilled in the art in view of the teachings hereof. The thread/container runtime 50 is alternatively referred to herein as the “thread/process/container allocation, management & runtime subsystem,” or the like.
Global object memory runtime 52. In the illustrated embodiment, this is implemented in runtime libraries, though, in other embodiments its functionality can be implemented through modification or supplementation of existing libraries, or otherwise, all as is within the ken of those skilled in the art in view of the teachings hereof. The global object memory runtime 52 is alternatively referred to herein as the “memory & file allocation and management subsystem,” or the like.
Object store subsystem 48. In the illustrated embodiment, this is implemented as part of the runtime framework executing on each of the plurality of the nodes, e.g., 14A, 14D, that make up system 10. In other embodiments, its functionality may be implemented in software libraries or otherwise, as is within the ken of those skilled in the art in view of the teachings hereof.

In operation, the aforementioned subsystems (i.e., the application environment adapter subsystem; the file, thread/process/container allocation, management & runtime subsystem; the memory & file allocation and management subsystem; and the object store subsystem) of each node feed events to local AI engine 44 and its attendant model 46 that learn the behavior of application software 36 for purposes of devising strategies for parallelizing it (as discussed below) and for interacting with multiple processors (or “cores,” as that term is used synonymously herein except where otherwise evident from context) local to node 14A and with other nodes 14B-14D that are executing software or data tiles generated from application 36 as a result of such parallelization as discussed below. The AI engine 44 and its attendant model 46 are alternatively referred to herein as the “ML subsystem,” or the like. As discussed below, the ML subsystem 44 generates commands, referred to as “action outputs,” that govern the behavior of the other subsystems, not only in local node 14A but also in the other nodes 14B-14D that are participating in parallelization of application software 36.

Persons skilled in the art will appreciate that the functionality of the subsystems described above may be implemented other than as shown in the illustrated embodiment without deviating from the spirit of the invention. Thus, for example, that functionality may be implemented in a greater number of software elements than shown here or, conversely, a lesser number, all as is within the ken of those skilled in the art in view of the teachings hereof.

### Overview of Operation

Together, processor 30, memory 32, OS 38 and libraries 40 of node 14A execute instructions of application software 36 maintained in that node in the conventional manner known in the art as adapted in accord with the teachings hereof. Typically, such execution is on request of a user, though it can be in response to a request of a machine or otherwise, all as per convention in the art as adapted in accord with the teachings hereof.

The above includes adaptations effected by the aforesaid TDAF subsystems, to wit, the adapters/hooks 42, AI engine 44, object store subsystem 48, thread/container runtime 50, and global object memory runtime 52 to parallelize or otherwise distribute execution of software 36 over multiple local cores and remote nodes by
identifying a parallelization strategy for application software 36,
generating commands, or “action outputs,” reflecting that strategy and transmitting or otherwise making those action outputs available to local adapters 42 for execution of the strategy by local processor cores and directly or indirectly (i.e., via “objects” based on those action outputs) to remote nodes, e.g., 14D, for execution of the strategy by their respective processor cores,
executing on multiple cores, local and/or remote, at least portions (“tiles”) of application software 36 on the data to be processed thereby in accord with the strategy embodied in the action outputs, and
gathering the results of execution of the software on those multiple cores for storage, use and/or presentation as if it were generated without parallelization.

The nodes 14A-14D use the above methodology to automatically parallelize execution of the application software 36 at runtime, that is, while processor 30 is executing the instructions of application 36. See, FIG. 2, Step 60.

This is discussed below with a focus, for ease of presentation, on parallelization initiated by node 14A; however, it will be appreciated that the other nodes 14B-14D can operate similarly. As used here and throughout, the terms “parallelize,” “parallelized,” “parallelization” and the like refer to making available software (e.g., application software 36) or portions thereof for execution on multiple local cores (e.g., within node 14A) and/or multiple nodes (e.g., node 14A and one or more of the other nodes 14B-14D) and the respective cores thereof, whether in parallel, in series or, more typically, a combination of both. As those skilled in the art will appreciate, execution of software “in parallel” means execution that occurs concurrently or substantially concurrently (i.e., execution that overlaps in time such that execution on one core or node does not complete before execution begins on another core or node); whereas, execution of software “in series” means that execution completes or substantially completes on one core or node before beginning on another core or node—at least, as regards processing of data dependencies of those respective cores and/or nodes.

### Scalable Hierarchical Distributed Object Store

Object store subsystem 48 is the local subsystem of system 10's distributed peer-to-peer object store, which utilizes global addressing (i.e., addressing common to all processing elements 14A-14D) and manifests as the “common memory” denoted in FIG. 2 and referred to as such throughout this application. This utilizes a distributed object directory 48B and a meta-data and object store 48A to orchestrate distributed execution location and object location to transparently control full parallel application execution. A network interface 48C supports remote object access. The object store subsystems 48 is alternatively referred to herein as the “distributed GA directory, meta-data and object store subsystem,” or the like. In the illustrated embodiment, the peer-to-peer object store that is defined, collectively, by the object store subsystems 48 of the respective nodes (e.g., 14A-14D) can store, physically, logically, virtually or otherwise, any type of data or other information (including, by way of non-limiting example, applications software, data, databases, object stores, and files, to name a few) for access by the respective nodes via their respective local subsystems 48. As indicated in the drawing, the object store subsystem 48 and/or other functionality contained within a node, e.g., 14A, can transfer content between its local memory 32 and that common memory, as is within the ken of those skilled in the art in view of the teachings hereof.

In system 10, the aforesaid objects are created and accessed via a Global Object Address (or “GA”) space, which is invariant across all nodes 14A-14D. As a result, the object stores 48A of the respective nodes 14A-14D of the system 10 collectively form a scalable hierarchical distributed object store, individual objects in which can be retrieved using their respective global addresses. Within each node, the respective ML subsystem 44 controls and utilizes the distributed object directory 48B and store 48A of subsystem 48 via issuance of action outputs. Each ML subsystem 44 can also issue action objects to localize objects ahead of their use—not only in the local object store 48A but also in object stores of other nodes.

Object retrieval and movement within the aforesaid hierarchical store is effected by the object store subsystems in response to commands from the ML subsystem 44, To that end, the illustrated embodiment can utilize data movement mechanisms of the sort known in the art for localizing data within a distributed processing system having a shared global memory, e.g., of the type disclosed in U.S. Pat. No. 5,251,308, entitled “Shared memory multiprocessor with data hiding and post-store”; U.S. Pat. No. 5,335,325, entitled “High-speed packet switching apparatus and method”; U.S. Pat. No. 5,282,201, entitled “Dynamic packet routing network”; U.S. Pat. No. 5,226,039, entitled “Packet routing switch”; U.S. Pat. No. 5,341,483, entitled “Dynamic hierarchical associative memory”; U.S. Pat. No. 5,313,647, entitled “Digital data processor with improved checkpointing and forking”; U.S. Pat. No. 5,742,806, entitled “Apparatus and method for decomposing database queries for database management system including multiprocessor digital data system,” as well as of the type taught in the publicly available Libfabric repository of GitHub, all by way of non-limiting example, and the teachings of all of the foregoing of which are incorporated by reference herein.

The object store subsystem 48 stores ObjectIDs (discussed below) and the content of objects (discussed below) on behalf of the nodes (e.g., 14A-14D) in which those ObjectIDs and objects are accessed. That subsystem 48 likewise stores relationships between objects as defined by action outputs (discussed below). As a consequence, all nodes can reference all ObjectIDs, objects, and relationships through the common memory made up by the collective local subsystems 48. In some embodiments, for example, this obviates the need to explicitly transfer objects between nodes over network 16 as discussed below, since availability of such objects via common memory makes this possible of its own.

### Identifying a Parallelization Strategy

AI engine 44 of node 14A is triggered to parallelize application software 36, beginning with identifying a parallelization strategy, when processor 30 of that node executes certain instructions or instruction types. In the illustrated embodiment, those are “calls,” that is, instructions to invoke functions provided by the operating system 38 and/or libraries 40. Other embodiments may vary in this regard and may, instead or in addition, trigger parallelization on execution of other instructions or instruction types and/or on events such as interrupts, all as is within the ken of those skilled in the art in view of the teachings hereof.

The illustrated embodiment detects the execution of calls contained in application software 36 by wrapping at least selected OS 38 and/or library functions with adapters 42 (a/k/a “hooks”) in the conventional manner known it the art as adapted in accord with the teachings hereof. When such a “wrapped” function is called, its adapter 42 receives and interprets that call in the first instance and may (or may not) pass it to the function after processing it in accordance with the teachings hereof. See, Step 62. The discussion below is directed to embodiments in which the detected call (or other instruction) is interpreted/processed and, in some instances, modified before being passed to an OS or library function. In other embodiments, such interpretation/processing and/or modification is more minimal, if performed at all. For the sake of brevity, without loss of generality, and unless otherwise evident from context, the term “intercepted” (along with its corresponding verbal, adjectival and other formatives, such as “intercepting”) is used in the discussion below to characterize such detected calls (or other instructions), regardless of the extent, if any, of interpretation/processing and/or modification of the calls (or other instructions) following its detection.

In the illustrated embodiment, the intercepted calls (which, as noted, can include merely detected calls) can include calls to functions forming part of the standard OS 38 or library 40 memory API (applications program interface), thread API, and/or file system API, by way of non-limiting example. They can also include calls to commercially available third-party library functions dedicated to process parallelization (e.g., OpenMP and CUDA), machine learning (e.g., PyTorch and TensorFlow) and/or other tasks that lend themselves to parallelization, all by way of non-limiting example. They can also include, instead or in addition, calls determined heuristically or otherwise to indicate that a specific application software 36 is about to execute a sequence of instructions, e.g., a loop or series thereof, that might benefit from parallelization. It will be appreciated that the intercepted calls or other instructions may not come from application software 36 itself but may be generated, in addition, by functions within the OS 38 or libraries 40, themselves.

Still other embodiments may forego adapters 42 in whole or in part and, instead, may rely on incorporation into application software 36 of calls to functions built for the purpose of triggering parallelization methodologies according to the invention. Yet still other embodiments may rely on the instruction pointer of processor 30, in connection with interpretation of the source code and/or object code from which application software 36 is generated, to detect when calls or other instructions of its are executed and to, thereby, trigger parallelization of application software 36, all by way of non-limiting example.

Regardless, upon intercepting a call (or other instruction), each adapter 42 can update state tables (not shown) maintained in AI engine 44, object store subsystem 48, thread/container runtime 50 and/or global object memory runtime 52 or otherwise to reflect a current state of application software 36 execution. The adapter can, in addition, generate a representation of the intercepted instruction and/or, in some embodiments, of the instructions (or “code”) of application software 36 in connection with which that instruction is executed and pass it to the AI engine 44 for use in identifying a strategy for parallelization of application software 36. See, Step 64. The discussion that follows generally centers on embodiments in which the representation generated by the adapter 42 is of the intercepted instruction. Those skilled in the art will appreciate that those teachings can be applied, as well, to embodiments in which the representation is of instructions/code of application software 36 in connection with which the intercepted instruction is executed (e.g., lines of code adjacent to, surrounding or bracketing the intercepted instruction, or a block, module, function, subroutine, or other programming construct in connection with which the intercepted instruction is contained or otherwise executed), as well as embodiments in which the representation is of (i) calls (or other instructions) generated by functions within the operating system or libraries, or (ii) calls (or other instructions) determined from interpretation of the source code and/or object code from which application software is generated.

The representation, which may be passed as parameters in calls to the AI engine 44 or otherwise, can be, for example, a “copy” of the intercepted instruction itself. This can be useful, for example, in embodiments that intercept calls to libraries, like OpenMP, OpenMPI and CUDA, in which data and software instruction sequences that are potential targets for improved parallelization strategies—as well as the context or state under which that parallelization must be executed—may be evident from the calls themselves or from other instructions in application software 36 executed in connection therewith.

In the illustrated embodiment, that representation instead (or in addition) takes the form of the action outputs detailed below and, thereby, defines block objects, data objects, task objects and thread objects of the type described below suitable for execution of the intercepted call (or other instruction), although (as generated by an adapter 42) not optimized to effect a parallelization strategy of the type discussed below. Indeed, in some embodiments, such a representation is not suitable, prior to action by the local AI engine 44, to effect parallel execution of the intercepted instruction or, more generally, of the application software 36—but, rather, may only be suitable for continuing execution of that instruction (and, more generally, application software 36) on the processor core 30 and in the thread whence it was intercepted.

Regardless, such a representation can reference (i) software instruction sequences and data sets requiring parallelization, (ii) tasks linking those instructions and data, and (iii) a processing environment (e.g., environmental variables and other state information) in connection with which such processing should be performed (whether locally or in a remote node) to achieve results that would be the same as if the intercepted instruction were not intercepted at all and, instead, the application software 36 from which it arose executed to completion on node 14A. The representation generated by the adapter 42 differs from action outputs generated by the AI engine 46 insofar as the latter take into account the availability of processor and other resources, both local to node 14A and remote therefrom (as well as the “knowledge” embedded in model 46 of parallelization strategies and outcomes thereof) and, as a consequence, the latter tailor and optimize definition of the aforesaid constructs as discussed below to the availability of resources within and remote to the local node 14A.

In still other embodiments, an adapter 42 generates a representation of an intercepted call (or other instruction) that is an abstraction of the instruction, either itself or in the context of portions of application software 36 executed in connection therewith. Such an abstraction can be, for example, a numerical or other code (e.g., a hash code) that encodes not only the identity of a library function that is a target of an intercepted call, for example, but also of a matrix, tensor or other data structure to be processed thereby. Alternatively, or in addition, such an abstraction can be a characterization of the context within application software 36 within which the intercepted call is executed. These and other abstractions and, more generally, representations of the intercepted call (or other instruction) are within the ken of those skilled in the art in view of the teachings hereof.

In embodiments that forego adapters 42 and, instead, rely in whole or in part on incorporation into applications software 36 of calls to functions built for the purpose of triggering parallelization methodologies according to the invention, this same information can be passed by those functions to the AI engine 44. It will be appreciated that these are examples, and that other embodiments may pass different information, instead or in addition, to the AI engine 44, whether as parameters to calls or otherwise.

### AI Engine

On receiving a representation from an adapter 42, AI engine 44 of node 14A applies that representation along with information regarding the state of the application software 36 currently under execution in the node 14A to model 46 in order to determine a strategy, if any, for parallelization of that software. See, Step 65. In the illustrated embodiment, the model 46 is implemented as a “decision transformer,” although reinforcement learning (RL) or other ML techniques and/or optimizations thereof may be used instead or in addition. A preferred decision transformer is of the type disclosed in “Decision Transformer: Reinforcement Learning via Sequence Modeling,” Chen et al, arXiv:2106.01345 (2021), the teachings of which are incorporated herein by reference, and which can be implemented in the manner taught in the publicly available “decision-transformer” repository of GitHub.

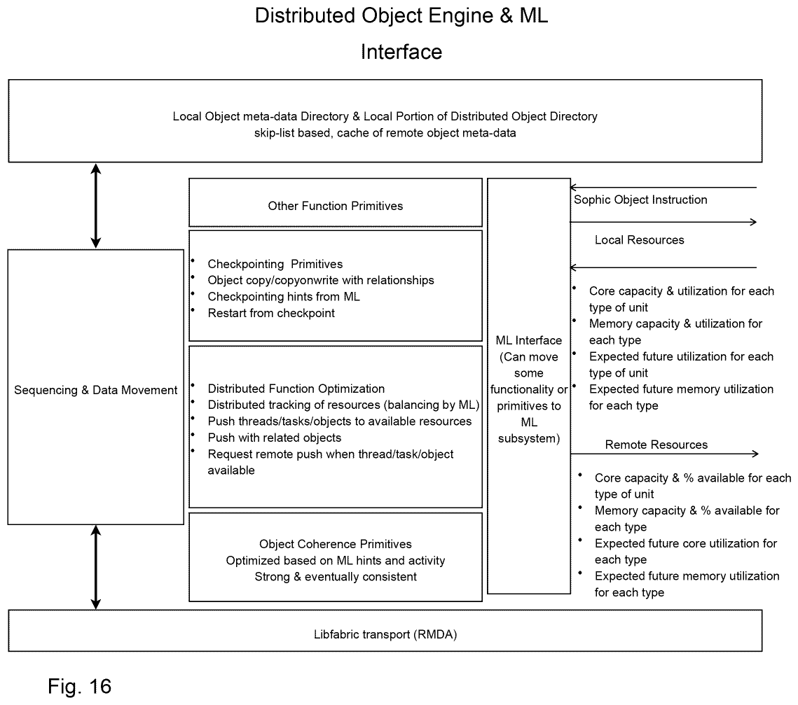

With additional reference to FIG. 16, in addition to the adapter-generated representation (which, as noted above, in the illustrated embodiment, takes the form of action outputs), the AI engine 44 also applies to the model 46 the following resource capacity and usage metrics (current and expected future), though, again, other embodiments may vary in this regard:
Local memory capacity and availability (current and expected future) as determined from local runtime subsystem 52 and shared to the common memory;
Local thread capacity and availability (current and expected future) of each local processor core type (e.g., CPU, GPU, SPU, etc.) from local runtime subsystem 50 and shared to the common memory;
Distributed memory capacity and percent availability (current and expected future), as determined from object store subsystem 48 or the common memory; and

Distributed thread capacity and percent availability (current and expected future) of each remote processor core type (e.g., CPU, GPU, SPU, etc.), as determined from object store subsystem 48 or the common memory;

As used above and throughout this application, the terms “distributed memory capacity and availability”, “distributed thread capacity and availability,” and the like, refer, respectively, to collective capacity and availability of the local memory and processor cores of remote nodes (e.g., in this case, nodes 14B-14D).

The model 46 is trained to determine from those inputs (i.e., the adapter 42 representation and the resource capacity and availability metrics) a parallelization strategy that optimizes the overall speed of execution (and, more particularly, “time to completion”) of application software 36 and to generate that strategy in the form of action outputs—so named because they represent “actions” output of the ML model 46—comprising commands to the local node's subsystems (i) for parallelization of the application software 36 on the local processor cores and/or (ii) for generation of objects of the type described below to effect parallelization on remote nodes. (Other embodiments may be trained to optimize in other manners, e.g., utilization (e.g., minimization of use) of computing resources, energy consumption and so forth, all is within the ken of those skilled in the art in view of the teachings hereof.)

In the illustrated embodiment, the action outputs reflect (i) whether execution of application software 36 and particularly, for example, of a portion of that software demarcated by the intercepted instruction that triggered the parallelization effort is likely to benefit from parallelization—if not, the action outputs generated by the model 46 may mirror the adapter 42 representations that were input to it in Step 65 and result, e.g., in execution of the call (or other instruction) intercepted in Step 62 without parallelization—of, if so (i.e., parallelization is likely to provide such benefit), (ii) an appropriate level of task-level parallelism and appropriate thread resources (e.g., processing cores) to be applied in connection therewith, e.g., as reflected by action outputs to effect thread object creation, (iii) within a task, whether parallelism can be achieved through independent data objects and identifying an appropriate level of thread resources to be applied in connection therewith, e.g., again, as reflected by action outputs to effect thread object creation, (iv) within a task, whether parallelization to achieve that benefit ought be effected through tiling of instructions or data or both and, if so, (v) parameters for that tiling (e.g., starting/ending points, rows/columns, etc.).

In these latter regards, the action outputs generated by the model 46 define block, data and task objects to effect a tiling strategy in accord with those parameters
block objects (of the type discussed below) containing, identifying or otherwise referencing instruction “tiles” (i.e., sequences of instructions) from application software 36 to be executed by remote nodes in connection with parallelization application software 36 over multiple nodes;
data objects (of the type discussed below) containing, identifying or otherwise referencing data “tiles” (i.e., subsets of data) upon which those instruction tiles are to be executed by the remote nodes;
task objects (of the type discussed below) associating block objects referencing instruction tiles with data objects referencing data tiles upon which the instruction tiles of those block objects are to be executed.
thread objects (of the type discussed below) defining environmental variables and other state information in connection with which task objects are to be executed.

As used herein, the word “tiling” (as applied to instructions, e.g., of application software 36, means identifying a subset or subsequence (or “tile”) of those instructions, though, in some instances that tile might comprise the entirety of application software 36; and, as applied to data, the term tiling means identifying a subset of data, e.g., on which the instructions of application software 36, or a tile thereof, are to be applied (or, put another way, data that is processed by application 36 or a tile thereof), though, again, that subset might comprise the entirety of the data. In the illustrated embodiment, the output of the model 46 is made with respect to the overall context of the application software 36, the local and remote resources.

More generally, as used above and throughout this application, except where otherwise evident from context, the terms “tiling”, “to tile”, “tiled”, and the like, are used synonymously to mean identifying, discerning, defining, determining and/or creating a “parallel unit of work” (or PUoW) dynamically, i.e., during runtime execution of software being parallelized (e.g., application software 36)—and, more particularly, during runtime execution of a set of one or more instructions defining a task that can be executed synchronously, asynchronously or otherwise with respect to that and/or other tasks to be parallelized, where such set of one or more instructions make up such software and/or are invoked thereby (e.g., as in the case of a library function called by such software). A PUOW, which can include or otherwise be based on such set of one or more instructions, is itself a set of instructions to be executed in parallel (or in series) and/or a set of data to be processed (by such a set of instructions or otherwise) in parallel (or in series) as a consequence of and/or to put to effect such parallelization. Likewise, the term “tile”, “tiles”, and the like, as used herein, refers to such dynamically identified, discerned, defined, determined and/or created PUoWs.

### Additional Optimizations

In some embodiments, the AI engine 44 and/or object store subsystem 46 modify action outputs generated by ML model 46 to achieve additional optimizations of the parallelization strategy, for example:
localizing instructions and data—i.e., minimizing unnecessary movement to, from and among remote nodes of instructions, source data (i.e., data to be processed by those instructions), and results data (i.e., data resulting from that processing)—both in connection with the parallelization of that software 36 by local node 14A and in connection with potential additional parallelization(s) by remote nodes (e.g., 14B-14D) involved in processing instruction and data tiles in connection therewith. This includes pushing action outputs and/or the objects pertaining to execution of the same or related instructions and/or data (e.g., the instructions of and/or data processed by software application 36) to the same nodes and/or nodes that are “nearby” one another from an instruction or data movement perspective, as the case may be, in view of network 16 capabilities and/or local and common memory allocation;
load balancing among nodes. This includes pushing action outputs and/or the objects pertaining to execution of software application 36 to nodes having sufficient resources;
generating action outputs and/or task objects for requesting that, when it/they become available, tasks and/or data be pushed to a given node; and/or.
“checkpointing” of threads executed by the local and remote nodes in connection with parallelization of application software 36—to wit, moving instructions, source and results data between nodes at intermediate points during execution in order to preserve a history of that execution on a succession of nodes from which movement is effected.

Modification of action outputs to achieve these additional optimizations is within the ken of those skilled in the art in view of the teachings hereof and, in the illustrated embodiment, is a function of the following additional metrics:
Checkpointing status of threads executing on local and remote processor cores, as determined from and shared to common memory; and
Locality of (i.e., identification/location of nodes executing) related threads executing instructions from the same application software 36 and/or processing the same or related data, as determined from and shared to common memory.

One or more of the aforesaid additional optimizations can be achieved by the model 46 itself, instead or in addition, through corresponding training and metrics, all is within the ken of those skilled in the art in view of the teachings hereof.

### Generating Action Outputs and Objects

Through the process above, the AI engine 44 of node 14A encodes a specific parallelization strategy into a series of one or more commands, i.e., action outputs, which it effects (or puts into action) on processor cores local to node 14A and/or on processor cores of remote nodes 14B-14D—in the former case, by pushing (via APIs or otherwise making available, e.g., via shared memory) those action outputs to the adapters 42 and subsystems 50, 52 of node 14A; and, in the latter case, by pushing or otherwise making those action outputs available to the local object store subsystem 48, causing it to generate and transmit (e.g., over network 16) or otherwise make available (e.g., via system common memory) to the remote nodes block, data, task and thread objects based on those action outputs so that those remote nodes can take over from or participate with node 14A in execution of the parallelized application software 36. See, Steps 66, 68, respectively. Although the aforesaid objects embody the action outputs on which they are based, the node 14A can distribute the action outputs to remote nodes 14B-14D, as well, as discussed elsewhere herein.

In addition to putting the action outputs into effect, as discussed immediately above, the adapter 42 and object store subsystem 48 can update metrics in common memory reflecting how local and remote resource capacity, respectively, will be affected when the strategy reflected in those action outputs is put into effect. Thus, for example, adapter 42 can update common memory to reflect how implementation of the strategy will impact future local memory and thread availability, while subsystem 48 can update common memory to reflect how remote memory and thread capacity, collectively, will be so impacted, all as is within the ken of those skilled in the art in view of the teachings hereof.

In the illustrated embodiment, the AI engine 44 makes a determination on whether to push the action outputs to the adapters 42 and subsystems 50, 52 to effect local parallelization of tiles of the application software 36, on the one hand, and/or whether to push those action outputs to local subsystem 48 to effect parallelization of such tiles on remote nodes, as a function of decisions made by the model 46 reflected in fields of those action outputs (e.g., the srcDest field, noted elsewhere herein), though, other embodiments may vary in this regard.

In the illustrated embodiment, action outputs take the form of a Common Instruction Abstraction, defined in the table below, and embody the following information, where the fields are described in the enumeration column

Common Instruction Abstraction

| Field | Enumeration |
|---|---|
| Operation | Operations that define object types and object |
| | relationships |
| objectID | Defines key object meta information (see previous |
| | slide) |
| addrObject | Defines object address consisting of |
| | objectNumber and offset |
| srcDest | Determines whether status and actions to/from |
| | ML are with respect to local adapter or local |
| | instance of distributed objectStore |
| dataFlow | Specifies the type of remote operation to/from |
| | ML to distributed object store |
| Priority | Specifies operation as demand or anticipation |

ObjectIDs as used in the instructions defined above include the following, where Units_of_work=ObjectSize/ObjectScalingFactor and units_of_work are typically the maximum parallelism, but usually multiple units_of_work are assigned to a single thread:

ObjectID

| Field | Enumeration |
|---|---|
| Address | struct{uint64_t object, uint64_t offset} |
| threadStatus | Enum{uninitialized, initialized, executing, |
| | executingWait, mergeWait, complete} |
| Type | enum{block, data, task, meta, thread} |
| Size | uint64 t_size |
| Hint | “Sharing{nonshared, shared, sharedRead, |
| | sharedWrite, sharedScalingField} |
| | temporal{noTemporal, readTouchOnce, |
| | writeTouchOnce, writeProducer, readConsumer}” |
| Scaling | {none, Independent, RO, SingleUpdate, |
| | RowMajor, ColMajor, tensor, other} |
| ScalingFactor | “uint64_t factor (applies to Object scaling)- units |
| | of object scaling or uint64_t independent groupID |
| | specifies meta object for object list” |

The operation (or “command”) field included in the action outputs include the following, by way of non-limiting example, which are occasionally referred to in the discussion that follows and elsewhere herein without the “soi” prefix and underscores.
soi_block—create a block (“function”) object;
soi_data_object_create—create a data object;
soi_task_define—define a task object to be created (e.g., by object store subsystem);
soi_task_block_object—associate a block (“function”) object with a task object;
soi_task_data_object—associate a data object with a task object;
soi_task_end—end definition of task object;
soi_task_merge—define a task object as merging results of processing by one or more other task objects;
soi_task_split—define a task object as split from another task object;
soi_thread_define—define a thread to be created (e.g., by AI engine);
soi_thread_assign—associate (assign) a task object with a thread;
soi_thread_deassign—deassign a task object from a thread; and
soi_object_destroy—destroy an object.

With respect to Step 68, action outputs can be transmitted or otherwise distributed directly to the other nodes in order to implement a parallelization strategy; however, in the illustrated embodiment, objects of the type described below defined by or otherwise embodying those action outputs are transmitted or otherwise distributed to those remote nodes instead (or, in addition) in order to implement that strategy. See, Step 69. Other than thread objects, those objects are created by the local object store subsystem 48 of node 14A in response to action outputs issued by the local AI engine 44. See, Step 68.

Particularly, in response to action outputs generated by the AI engine defining instruction tiles and data tiles, the subsystem 48 generates block objects and data objects, respectively; in response to those defining tasks linking those instructions and data and specifying an order or manner in which processing is to be performed by the former on the latter, the subsystem 48 generates task objects. In embodiments of the type discussed below in which objects are created concurrently with their corresponding action outputs, the foregoing steps are not necessary, unless the action outputs generated by the AI engine necessitate changing existing objects or generating entirely new ones. Regardless, the local object store subsystem distributes the block objects, data objects, task objects, and thread objects to the other nodes (with assistance of the I/O logic 34). See, step 69.

Though some embodiments may vary in this regard, the AI engine 44 of the illustrated embodiment does not rely on the local object subsystem 48 to generate thread objects, i.e., objects defining environmental variables and other state information in connection with which task objects are to be executed—or, put another way, in which the processing of the data associated with data objects is to be processed by instructions associated with block objects. Instead, the AI engine 44 of the illustrated embodiment generates those thread objects itself, which it transmits or otherwise distributes to the remote nodes 14B-14D, also in Step 69. Other embodiments may vary in this regard.

In the illustrated embodiment, the syntax of action outputs (on the one hand) and delineation/content of objects (on the other hand) are such the one can be derived from the other and vice versa. Thus, just as block, data, task and thread objects of the illustrated embodiment are created from action outputs, e.g., by the subsystems 44 and 48 as discussed above, so too can those action outputs be re-created (or inferred) from those objects. Systems in accord with the invention can take advantage of this by foregoing transmission/distribution to remote nodes of action outputs and, instead, can rely on those remote nodes to re-create/infer those action outputs (if and as necessary) from the objects created from them. Other embodiments may vary in this regard. In embodiments of the type discussed below in which objects are created concurrently with and used in place of their corresponding action outputs, the re-creation (or inference) of action outputs is typically not required because the nodes and their respective subsystems are implemented to perform all necessary steps using objects themselves.

Regardless of whether action outputs can be so inferred from such objects and/or are otherwise transmitted/distributed along with them, the AI engines 44 of remote nodes, e.g., 14B-14D, that receive such objects and/or action outputs from the node that originated them, e.g., 14A, can use those objects and/or action outputs to further refine the parallelization strategy reflected in them and to generate still further action outputs and objects that embody that further refined strategy. Indeed, in some embodiments, the AI engine 44 of the originating node, e.g., 14A, can off-load to AI engine(s) of remote node(s) some (or, potentially, all) of the task of parallelizing application software 36 in connection with which the triggering call (or other instruction) was intercepted in step 62.

In the illustrated embodiment, an object includes the fields identified in the table above labelled “ObjectID”. With respect to that table, the field Address specifies the object identifier within the object storage subsystem which spans across all participating nodes. Each instance of the Object Store Subsystem on a node, 48, transparently maintains a mapping of the object into the local system physical address space and process(s) virtual address space.

With respect to the ObjectType field, this identifies the object type including, in the illustrated embodiment,
a block object or “block,” including, referencing as described in connection with the “ObjectID” or otherwise associated with an instruction tile, i.e., the application software 36 or portion thereof to be executed by one or more remote nodes, e.g., 14B-14D, in carrying out the parallelization of application software 36. In the drawings and elsewhere in the discussion herein, the instruction tile is alternatively referred to as a “function”;
a data object, including, referencing as described in connection with the “ObjectID” or otherwise associated with a data tile, i.e., the data or subset thereof upon which software in one or more block objects is to be executed in carrying out the parallelization of application software 36;
a task object, referencing or otherwise associated with a block object and one or more data objects that, themselves, are associated with data to be processed by the software associated with that block object, and the order or other manner in which that processing is to be performed by one or more threads that, through assignment of thread objects, take up processing of that data using that software. In the illustrated embodiment, examples of that order or manner of processing include data dependencies between data objects and, within data objects, row major, column major, independent, tensor and single-update, and the like;
a thread object referencing or otherwise associated with a task object and defining environmental variables and other context or “state” in which instructions associated with a block object associated with that task object are to be executed while processing data in a data object associated with that task object in order to effect parallelization of the application software 36 across multiple nodes and their respective processor cores
a meta object, is a custom object that contains a list of objects or objectIds and is interpreted by a block object. Typically a meta object is utilized to specify a list of objects for a common operation.

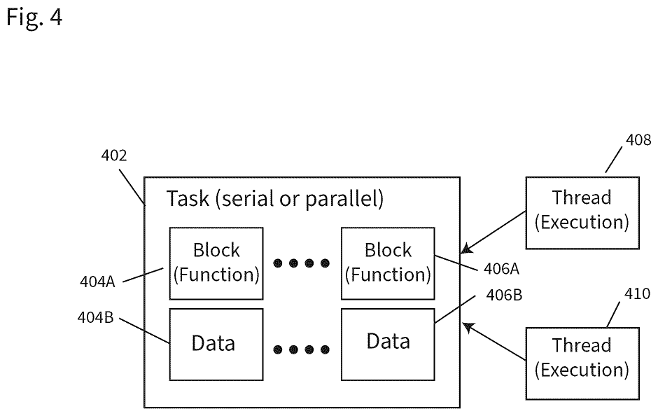

FIG. 4 depicts relationships among block, data, task and data objects in a system according to one practice of the invention. As shown there, a task object 402 defines pairs 404A, 404B, 406A, 406B of block (function) objects and data objects that make up a serial or parallel task. Multiple thread objects 408, 410 define environmental variables and other state for execution of a function specified in a respective block object 404A, 406A on the data specified in the corresponding data object 404B, 406B.

While block or block-type objects of the illustrated embodiment are each associated with instructions making up software to be executed; data or data-type objects, with data to be processed by those instructions; task or task-type objects, associate a block-type object with one or more data-type objects; and, thread or thread-type objects, define environments for processing of data-type objects by block-type objects, it will be appreciated that the fields, content and delineation between such objects may vary by embodiment and, thus, that the foregoing is by way of example.

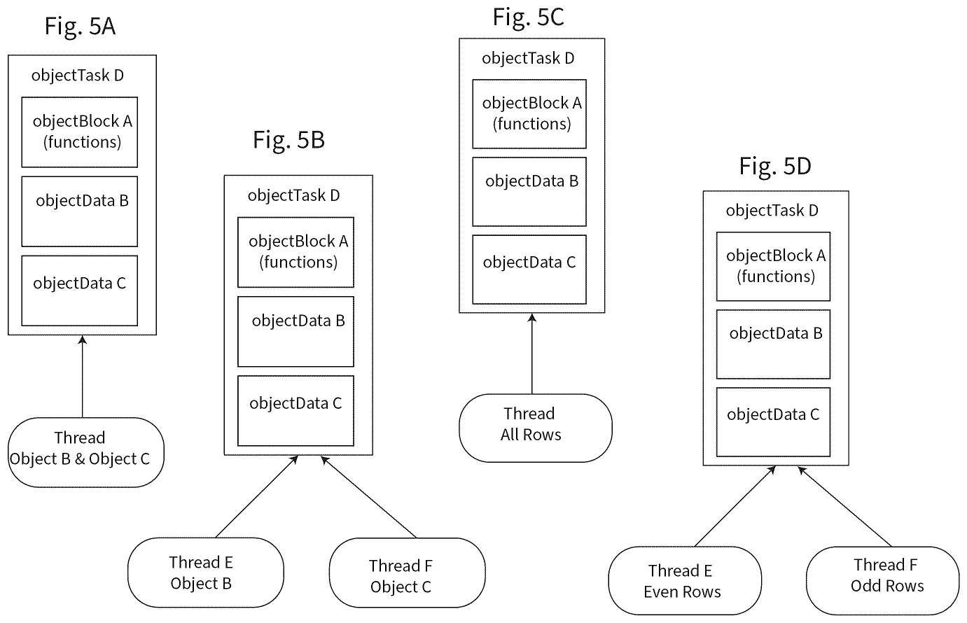

A more robust appreciation of the illustrated embodiment may be appreciated from the example below, showing the form of adapter 42 representations to AI engine 44 or action outputs generated by the AI engine 44 for purposes of generating blocks, data objects, task objects and threads for parallelizing a sequence of instructions from application software 36 (e.g., a static loop) that is to be executed serially by multiple cores and/or nodes. A graphic depiction of the task is provided in FIG. 5A.

| Explanation | Action Output (“Command”) | Command Parameter |
|---|---|---|
| Define blocks and | soi_block, | soi_objectBlock A |
| data objects | soi_data_object_create | soi_objectData B, sizeB, |
| | | soi_independent |
| | soi_data_object_create | soi_objectData C, sizeB, |
| | | soi_independent |
| Define tasks object | soi_task_define | soi_objectTask D, sizeB, |
| | | soi_independent |
| | soi_task_block_object | soi_objectTask D, object A |
| | soi_task_data_object | soi_objectTask D, object |
| | | B, sizeB, soi_independent |
| | soi_task_data_object | soi_objectTask D, object |
| | | C, sizeB, soi_independent |
| | soi_task_end | soi_objectTask D |
| Define thread and | soi_thread_define | soi_objectThread E |
| execute task | soi_thread_assign | soi_objectThread E, object D |
| | soi_thread_deassign | soi_objectThread E, object D |
| Destroy objects | soi_object_destroy | object A |
| | soi_object_destroy | object B |
| | soi_object_destroy | object C |
| | soi_object_destroy | object D |
| | soi_object_destroy | object E |

The example below shows the form of adapter 42 representations to AI engine 44 or action outputs generated by the AI engine 44 for purposes of generating blocks, data objects, task objects and threads for parallelizing a sequence of instructions from application software 36 (e.g., a static loop) that is to be executed in parallel by multiple cores and/or nodes. A graphic depiction of the task is provided in FIG. 5B.

| Explanation | Action Output (“Command”) | Command Parameter |
|---|---|---|
| Define blocks and | soi_block, | soi_objectBlock A |
| data objects | soi_data_object_create | soi_objectData B, sizeB, |
| | | soi_independent |
| | soi_data_object_create | soi_objectData C, sizeB, |
| | | soi_independent |
| Define tasks object | soi_task_define | soi_objectTask D, sizeB, |
| | | soi_independent |
| | soi_task_block_object | soi_objectTask D, object A |
| | soi_task_data_object | soi_objectTask D, object |
| | | B, sizeB, soi_independent |
| | soi_task_data_object | soi_objectTask D, object |
| | | C, sizeB, soi_independent |
| | soi_task_end | soi_objectTask D |
| Define thread and | soi_thread_define | soi_objectThread E |
| execute task | soi_thread_define | soi_objectThread F |
| | soi_thread_assign | soi_objectThread E, object D |
| | soi_thread_assign | soi_objectThread F, object E |
| | soi_thread_deassign | soi_objectThread E, object D |
| | soi_thread_deassign | soi_objectThread E, object E |
| Destroy objects | soi_object_destroy | object A |
| | soi_object_destroy | object B; |
| | soi_object_destroy | object C |
| | soi_object_destroy | object D |
| | soi_object_destroy | object E |
| | soi_object_destroy | object F |

The example below shows the form of adapter 42 representations to AI engine 44 or action outputs generated by the AI engine 44 for purposes of generating blocks, data objects, task objects and threads for parallelizing a sequence of instructions from application software 36 (e.g., a static loop) that is to be executed serially in row major order by multiple cores and/or nodes. A graphic depiction of the task is provided in FIG. 5C.

| Explanation | Action Output (“Command”) | Command Parameter |
|---|---|---|
| Define blocks and | soi_block, | soi_objectBlock A |
| data objects | soi_data_object_create | soi_objectData B, sizeB, rowMajor, |
| | | scaleB |
| | soi_data_object_create | soi_objectData C, sizeB, rowMajor, |
| | | scaleB |
| Define tasks object | soi_task_define | soi_objectTask D, sizeB, rowMajor, |
| | | scaleB |
| | soi_task_block_object | soi_objectTask D, object A |
| | soi_task_data_object | soi_objectTask D, object |
| | | B, sizeB, rowMajor, scaleB |
| | soi_task_data_object | soi_objectTask D, object |
| | | C, sizeB, rowMajor, scaleB |
| | soi_task_end | soi_objectTask D |
| Define thread and | soi_thread_define | soi_objectThread E |
| execute task | soi_thread_assign | soi_objectThread E, object D |
| | soi_thread_deassign | soi_objectThread E, object D |
| Destroy objects | soi_object_destroy | object A |
| | soi_object_destroy | object B; |
| | soi_object_destroy | object C |
| | soi_object_destroy | object D |
| | soi_object_destroy | object E |

The example below shows the form of adapter 42 representations to AI engine 44 or action outputs generated by the AI engine 44 for purposes of generating blocks, data objects, task objects and threads for parallelizing a sequence of instructions from application software 36 (e.g., a static loop) that is to be executed in parallel in row major order by multiple cores and/or nodes. A graphic depiction of the task is provided in FIG. 5D.

| Explanation | Action Output (“Command”) | Command Parameter |
|---|---|---|
| Define blocks and | soi_block, | soi_objectBlock A |
| data objects | soi_data_object_create | soi_objectData B, sizeB, rowMajor, |
| | | scaleB |
| | soi_data_object_create | soi_objectData C, sizeB, rowMajor, |
| | | scaleB |
| Define tasks object | soi_task_define | soi_objectTask D, sizeB, rowMajor, |
| | | scaleB |
| | soi_task_block_object | soi_objectTask D, object A |
| | soi_task_data_object | soi_objectTask D, object |
| | | B, sizeB, rowMajor, scaleB |
| | soi_task_data_object | soi_objectTask D, object |
| | | C, sizeB, rowMajor, scaleB |
| | soi_task_end | soi_objectTask D |
| Define thread and | soi_thread_define | soi_objectThread E (num threads |
| execute task | | based on calc) |
| | soi_thread_define | soi_objectThread F |
| | soi_thread_assign | soi_objectThread E, object D |
| | soi_thread_assign | soi_objectThread F, object E |
| | soi_thread_deassign | soi_objectThread E, object D |
| | soi_thread_deassign | soi_objectThread E, object E |
| Destroy objects | soi_object_destroy | object A |
| | soi_object_destroy | object B; |
| | soi_object_destroy | object C |
| | soi_object_destroy | object D |
| | soi_object_destroy | object E |
| | soi_object_destroy | object F |

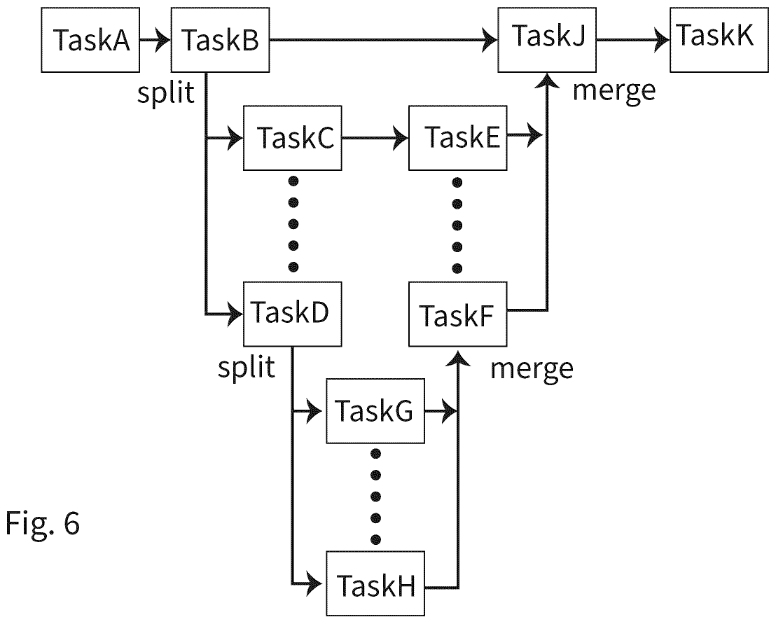

The example below shows the form of adapter 42 representations to AI engine 44 and action outputs generated by the AI engine 44 for purposes of generating task objects for parallelizing a sequence of instructions from application software 36 that is to be “split” that is, in this example, tiled (in instruction tiles, data tiles or both) among further tasks for parallel and/or series execution and the results merged, as evident in the commands shown in the tables and as depicted in FIG. 6. Action outputs generated by the AI engine 44 to define blocks and data objects for that same purpose are within the ken of those skilled in the art in view of the teachings of the examples above. As noted above, it will be appreciated that, in the example below and those above, the sequence of commands that define the task objects are preferably interpreted as a data flow graph and that, as a consequence, the individual “instructions” will not necessarily be executed in the illustrated sequence by the nodes 14A-14D but, rather, will be executed in an order determined by data dependencies between them, all as is within the ken of those skilled in the art in in view of the teachings hereof.

| Adapter SOI ML input | Resource ML input | −>ML SOI action |
|---|---|---|
| soi_task_split, soi_objectTask A, Task A | {cpuResource, | soi_thread_define, |
| | cpuResource} | soi_objectThread $ |
| | | soi_unassigned |
| soi_thread_define, soi_objectThread M | | soi_thread_assign, |
| soi_unassigned | | soi_objectThread M |
| | | uninitialized, Task A |
| soi_task_split, soi_objectTask B, Task A | {cpuResource, | |
| | cpuResource-1} | |
| soi_thread_define, soi_objectThread M, | | soi_thread_assign, |
| soi_complete, Task A | | soi_objectThread M |
| | | uninitialized, TaskB |
| soi_task_split, soi_objectTask C, Task B | {cpuResource, | soi_thread_define, |
| soi_task_split, soi_objectTask D, Task B | cpuResource} | soi_objectThread $ |
| | | soi_unassigned |
| soi_thread_define, soi_objectThread M, | | soi_thread_assign, |
| soi_complete, Task B | | soi_objectThread M |
| soi_thread_define, soi_objectThread N | | uninitialized, Task C |
| soi_unassigned | | soi_thread_assign, |
| | | soi_objectThread N |
| | | uninitialized, Task D |
| soi_task_split, soi_objectTask E Task C | {cpuResource, | soi_thread_define, |
| soi_task_split, soi_objectTask G, Task D | cpuResource-2} | soi_objectThread $ |
| soi_task_split, soi_objectTask H, Task D | | soi_unassigned |
| soi_thread_define, soi_objectThread P | {cpuResource, | soi_thread_assign, |
| soi_unassigned | cpuResource-1} | soi_objectThread N |
| soi_thread_define, soi_objectThread N, | | uninitialized, Task G |
| soi_complete, Task D | | soi_thread_assign, |
| | | soi_objectThread P |
| | | uninitialized, Task H |
| soi_thread_define, soi_objectThread M, | {cpuResource, | soi_thread_assign, |
| soi_complete, Task C | cpuResource-2} | soi_objectThread M |
| | | uninitialized, Task E |
| soi_task_merge, soi_objectTask F, Task D | {cpuResource, | |
| soi_task_merge, soi_objectTask F Task G | cpuResource-3} | |
| soi_task_merge, soi_objectTask F Task H | | |
| soi_thread_define, soi_objectThread N, | {cpuResource, | |
| soi_complete, Task D | cpuResource-2} | |
| soi_task_merge, soi_objectTask J, Task B | | |
| soi_task_merge, soi_objectTask J Task E | | |
| soi_task_merge, soi_objectTask J Task F | | |
| soi_thread_define, soi_objectThread N, | {cpuResource, | soi_thread_assign, |
| soi_complete, Task G | cpuResource} | soi_objectThread M |
| soi_thread_define, soi_objectThread P, | | uninitialized, Task F |
| soi_complete, Task H | | soi_thread_assign, |
| | | soi_objectThread N |
| | | uninitialized, Task J |
| soi_task_split, soi_objectTask K, Task J | {cpuResource, | |
| soi_task_split, soi_objectTask K, Task K | cpuResource-2} | |
| (end) | | |
| soi_thread_define, soi_objectThread M, | {cpuResource, | soi_thread_assign, |
| soi_complete, Task F | cpuResource-1} | soi_objectThread M |
| | | uninitialized, Task K |
| soi_thread_define, soi_objectThread N, | {cpuResource, | soi_object_destroy, |
| soi_complete, Task G | cpuResource-1} | soi_objectThread N |
| | | soi_object_destroy, |
| | | soi_objectThread P |
| soi_thread_define, soi_objectThread M, | {cpuResource, | soi_object_destroy, |
| soi_complete, Task K | cpuResource} | soi_objectThread M |

In the example above, the exact ordering subject to task completion time; the exact number of threads subject to individual task parallelism and execution time; the model 44 can assign a thread prior to merge condition satisfaction; the thread will not execute until condition satisfied; completed or unassigned threads do not utilize resources,

The objects, which can take advantage of the distributed object directory that utilizes global addressing (i.e., addressing common to all processing elements 14A-14D), are generated by the object store subsystem 48 to reference the instructions (or, preferably, a thread or container embodying those instructions) making up the application portions and to reference the data upon which those instructions act. Objects can be defined in any format and contained in any construct (e.g., packets, records, tables, arrays, structs, and so forth) suitable for distribution over network 16 between nodes 14A-14D, transfer within the nodes themselves, and storage in and retrieval from their respective object store subsystems 48.

### Executing Action Outputs on Multiple Nodes

As noted above, in Steps 66, 68, the AI engine 44 of node 14A (the node that initiated the parallelization, in the example) encodes a strategy in action outputs through which it effects that strategy on processor cores local to node 14A and/or on processor cores of remote nodes 14B-14D—in the former case, by pushing or otherwise making available those action outputs to the local subsystems 14A, and in the latter case by transmitting or otherwise making available to the remote nodes block, data, task and thread objects that are based on and embody those action outputs (and, in some embodiments, the action outputs themselves) so that those remote nodes can take over from or participate with node 14A in execution of the parallelized application 36 and, indeed, in further parallelization of it. This is discussed below with respect to exemplary nodes 14A and 14D; the other nodes 14B-14C operate similarly.

With respect to Step 66, action outputs that are pushed/made available within node 14A (i.e., the “originating” node) are implemented by an adapter 42 within that node—for example, the adapter 42 that intercepted the instruction that triggered the parallelization. Those action outputs can, for example, command that adapter 42 to (i) instantiate threads with instructions paralleling or subsetting those from which the intercepted call originated and to assign those threads for execution on multiple processor cores (whether CPU, GPU, SPU or otherwise) within node 14A and/or (ii) to modify the intercepted call before it is passed to the OS 38 or library 40 function to which it was originally directed in the originating thread and/or in those newly instantiated threads so that execution of application software 36 on that and/or those cores of node 14A can be limited to a respective instruction tile and/or data tile defined in the parallelization strategy discussed above in connection with Step 65 and/or (iii) to modify the intercepted call in the originating thread and/or those newly instantiated threads to redirect it to an alternate library function, e.g., one in the global object memory runtime 52, by way of example. The adapter 42 can determine specifics for implementing the action output based on state tables maintained in the AI engine 44 or otherwise reflecting the state of the node 14A, its various resources and the current load on them, e.g., consistent with the factors discussed above used by AI engine 44 in determining whether to push action outputs to the local subsystems (and/or to distribute them to other nodes).

With respect to Step 68, upon receiving or otherwise obtaining thread objects and, in some embodiments, action outputs, generated by node 14A (Steps 72, 74), the AI engine 44 of receiving node 14D determines whether it has sufficient processor 30, memory 32 and other resources to take up processing of a task object associated with that thread object (i.e., the task object generated in connection with implementation of the same parallelization strategy by node 14A). It can determine this based on the size of the payload (i.e., the instructions and data, respectively) carried by or referenced in block and data objects associated with that thread object, the data flow dependencies indicated in the thread object, and the resources available within the node 14D itself, e.g., as reflected by state tables maintained in the AI engine 44 or otherwise reflecting the state of the node 14D, its various resources and the current load on them, e.g., consistent with the factors discussed above used by AI engine 44 in determining whether to push action outputs to the local subsystems (and/or to distribute them to other nodes). In some embodiments, if the local resources are insufficient, the receiving node 14D can either execute the thread(s), potentially, in a non-optimal manner, or send the thread to the local object store subsystem 48 with a command for the object store subsystem to find another node to accept the thread.

If local resources are sufficient, AI engine 44 of node 14D commands its associated object store subsystem 48, e.g., via issuance of additional action outputs (Step 76) or otherwise, to process the block, data and task objects associated with the selected thread object (i.e., the thread object received from node 14A), e.g., by loading the instructions (whether in the form of threads or otherwise) and/or data referenced in those objects into local memory 32. That AI engine 44 also commands (i) the local thread/container runtime 50 to instantiate a thread using state and other environment information contained in the selected thread object and (ii) local adapters 42, e.g., via issuance to them of action outputs received in Step 72 or generation of new action outputs based thereon, to effect execution of that thread by processor cores local to the (remote) node 14D in a manner paralleling that described above in connection with Step 66. See Steps 78, 80. As that execution begins on node 14D, the instructions contained in the block object received from node 14A are executed on the data contained in the corresponding data object in the same manner as discussed above in connection with Step 60-70. As a consequence, execution of those received instructions on that received data can, itself, trigger further parallelization of application software 36, albeit, in this example, spawned by node 14D following interception of a call (or other instruction) by one of its adapters 42 and processing of the representation generated by it by the AI engine 44 local to node 14D.

Although in some embodiments, a remote node (e.g., 14D) determines whether or not to take up processing of a thread object and its associated task object based, e.g., on local resource availability as described above, in other embodiments thread objects, task objects, block objects and data objects are targeted to selected remote nodes, e.g., by the node 14A that initiated the parallelization effort and that originated the thread, task, data and block objects to carry it out. In these embodiments, the ML model 46 of that initiating (or “originating”) node utilizes the same factors discussed above in connection with Step 65 in making such a determination, e.g., distributed memory and thread capacity of each processor core type & percent availability (current and expected future) and, preferably, such metrics specific to the individual remote nodes 14B-14D present in the system-which metrics can be shared, e.g., by way of the common memory or otherwise, as is within the ken of those skilled in the art in view of the teachings hereof.

In such embodiments, i.e., where thread and task objects are targeted to specific remote nodes, e.g., 14D, a targeted such node need not evaluate upon receipt of those objects whether it has sufficient resources but, rather, can take up their processing in turn or on a priority basis, e.g., depending on implementation specifics, again as is within the ken of those skilled in the art in view of the teachings hereof. If the selected/targeted remote node includes multiple processor cores, it can utilize factors of the sort discussed above in connection with Step 66 in deciding on which of those cores to instantiate a thread to effect processing in accord with the received thread, task, block and data objects.

Regardless of whether a remote node (e.g., 14D) determines whether or not to take up processing of thread, task and other associated objects based on local resource availability or whether that node is targeted to take up such processing (e.g., by originating node 14A) and does so as a matter of course, it need not wait until it has intercepted a call (or other instruction) in connection with execution of received instructions on received data to evaluate whether they present another parallelization opportunity and, if so, to trigger same.

Indeed, in some embodiments, the AI engine 44 of a remote node (e.g., 14D) can use the methodology discussed above in connection with step 65 to evaluate action outputs received from an originating node (e.g., 14A)—or inferred from objects created by that originating node from those action outputs—to discern from them a refined or extended strategy for parallelization of at least those instruction tiles and/or data tiles of application software 36 identified in those actual or inferred action outputs. (In embodiments in which the action outputs are inferred from objects, the AI engine 44 of the remote node may discern that strategy from the block and data objects alone and/or in combination with their associated task and/or thread objects, depending upon implementation specifics, e.g., whether the bounds or indexes of those applicable tiles are represented in the block and/or data objects, or otherwise, all as is within the ken of those skilled in the art in view of the teachings hereof). The AI engine 44 of the remote node fleshes out that strategy further and generates further action outputs and/or objects based thereon, e.g., in a manner paralleling that discussed above in connection with Steps 65, 66 and 68 and, more generally, under the headings “AI engine” and “Generating Action Outputs and Objects.” Those further action outputs and/or objects can replace or supplement those received from the originating node (e.g., 14A, in this example), thereby, refining or extending the strategy set in motion by it.

As a consequence of the foregoing, it will be appreciated that a remote node (e.g., 14D) can discern a (further) parallelization strategy for application software 36 executing on another node (e.g., 14A) and can generate (further) action outputs and block, data, task and thread objects based thereon to put that strategy into effect local to the remote node or remote therefrom.

When node 14D has completed processing of the instructions and/or data referenced in the objects received in connection with steps 72, 74, its AI engine 44 can issue action outputs to the local object store subsystem 48 to (i) push those results to the node 14A (or other node that initiated the parallelization effort) in the form of an action output and/or object, (ii) hold those results until pulled by that (or another) node, or (iii) execute a merge operation contained in the task object associated with the received thread object to combine those results with those generated by other nodes or local threads upon which the merge depends, all as is within the ken of those skilled in the art in view of the teachings hereof.

The illustrated embodiment operates in accord with a peer-to-peer model. Thus, for example, if during execution of a subsequence of instructions referenced in an object and associated action output received from node 14A, the AI engine 44 of node 14D (or another receiving node 14B-14C) identifies a strategy for parallelization of that subsequence on other nodes to improve execution from a speed or other perspective, that node can, itself, generate further action outputs and objects to carry out that strategy. It will be appreciated that extension of the teachings above to the distribution and execution of instructions and data by way of containers is within the ken of those skilled in the art.

When processing of all action outputs triggered by parallelization of application software 36 of node 14A have been completed, that node can assemble the results for presentation to the user or other entity that invoked application software 36 in the first instance, as is within the ken of those skilled in the art in view of the teachings hereof. Alternatively, a remote node, e.g., 14D, that has taken up processing of the action output(s) generated by node 14A for the parallelization can perform the assembly.

### Action Outputs & Objects

In some embodiments, action outputs are generated prior to the objects (e.g., block, data, task and thread object) based on them. In preferred embodiments action outputs and their corresponding objects are generated concurrently—e.g., as when an adapter 42 generates a representation in Step 64 following interception of a call (or other instruction). In such embodiments, block, data, task and thread objects with which those action outputs correspond are generated concurrently by the adapter 42, in the case of thread objects, and otherwise, by the object store subsystem 48, at the request of the adapter 42, and those objects (which can reference their corresponding action outputs) are passed to the AI engine in Step 66 in lieu of the action outputs themselves. Likewise, in such embodiments, objects corresponding to action outputs generated by the ML subsystem to reflect a parallelization strategy can be concurrently modified (if pre-existing) or created (e.g., by the ML subsystem itself, in the case of thread objects or, otherwise, by subsystem 48 at the request of the ML subsystem) at the time of action output generation and regardless of whether the strategy is to be effected on cores and subsystems local to the initiating node or on remote nodes, and those objects can be used (i.e., pushed, transferred, distributed, exchanged and processed) in lieu of action outputs, both locally and remotely, to effect such parallelization, all as is within the ken of those skilled in the art in view of the teachings hereof.

### Coordinated Determination and Implementation of Parallelization Strategies

As discussed above, in some embodiments of the invention, the AI engine 44 of a node, e.g., 14A, that initiates parallelization of application software 36 (or portion thereof) being executed by it determines a strategy for that parallelization, e.g., to optimize speed of execution/time to completion, that (i) takes into account, for example, resource capacity and availability (both current and expected future availability) of local and remote nodes, and (ii) accommodates load balancing among nodes, and/or (ii) supports checkpointing of threads. This can be effected as part of generation of a parallelization strategy by ML model 46 of that engine 44, though, it can be effected during subsequent fleshing-out of that strategy by the AI engine 44 itself.

In either instance, whether the resultant strategy and action outputs effecting it are executed on local cores and/or remote nodes (e.g., as determined by the srcDest field discussed above, or otherwise) is a function in these embodiments, at least in part, of the metrics applied to model 46 in connection with Step 65 discussed above, to wit, local memory capacity and availability (current and expected future), local thread capacity and availability (current and expected future) of each local processor core type, distributed memory capacity and percent availability (current and expected future) of the remote nodes collectively, and distributed thread capacity and percent availability (current and expected future) of the remote nodes for each processor core type. In addition, it can be a function of the additional metrics applied to the ML model 46 discussed above pertaining to relative resource usage on local and remote nodes, the checkpointing status of threads executing on local and remote processor cores, and the locality of related threads executing instructions from the same application software 36 and/or processing the same or related data.

Thus, in some embodiments, that strategy determines (i) the number of processor cores, system-wide, to be used to continue (or further) execution of that application software 36 in parallelized fashion, and (ii) of those, how many of the processor cores 30 local to the initiating node will be employed for that purpose (i.e., continuing execution of that application software 36). In some embodiments, those determinations are made on the aforementioned per-processor type thread capacity and availability metrics alone, though, they may also made on memory capacity and availability (current and expected future), as well as on the additional metrics discussed above.

To ensure that those local processor cores 30 do not become overburdened when parallelization of the application software 36 begins, the AI engine 44 local to initiating node 14A updates the local per-processor type thread capacity and local memory capacity metrics (e.g., in common memory) accordingly. Those metrics thus becomes available to remote nodes, e.g., 14D, for its/their use in making resource determinations for parallelization efforts initiated by them, whether on portions of the same application software 36 or on other application software being executed by them.

In such embodiments, and using a four-node embodiment of the type shown in FIG. 2 as an example of the foregoing, the illustrated system 10 is capable of executing software applications on each of at least m=2 nodes (i.e., nodes 14A, 14D) of n=4 nodes (i.e., nodes 14A-14D) of the illustrated digital system 10. To this end, a first of those m nodes (referred to elsewhere herein as “given” nodes), e.g., node 14A, performs the steps of
(i) at least beginning execution of a given respective application software 36, e.g., resident on that node;
(ii) with its local AI engine 44, determining a strategy for further execution of that given software application on multiple processing elements of the digital system and generating commands (e.g., action outputs) to effect that strategy;
(iii) with its local AI engine 44, determining at least a number of resources to be used for further execution of that given software application, where that determination is a function of availability of resources on that given node and on at least one other node, e.g., 14D, of the digital system;
(iv) determining an availability of resources on the given node, e.g., 14A, for execution of software applications other than that given software application, where that determination takes into account the determination of step (iii);
(v) making the commands directly or indirectly available to multiple processing elements of the digital system in order to effect further execution of that given software application on multiple processing elements in accord with the strategy, where those multiple processing elements include at least one other of the m given processing elements; and
(vi) making a result of the determination of step (iv) available to others of the m given nodes, e.g., 14D, for its use in making and implementing parallelization strategies.

As with other aspects of the illustrated embodiment, such coordination in the use of current and future thread, memory and other capacity metrics in the determination and implementation of parallelization strategies by the multiple nodes of system 10 include automated scalability (e.g., without human intervention), whether for multi-nodal systems where m and n are greater than 100, greater than 1000, greater than 10,000 and more, and often, where m is equal to n

### Example

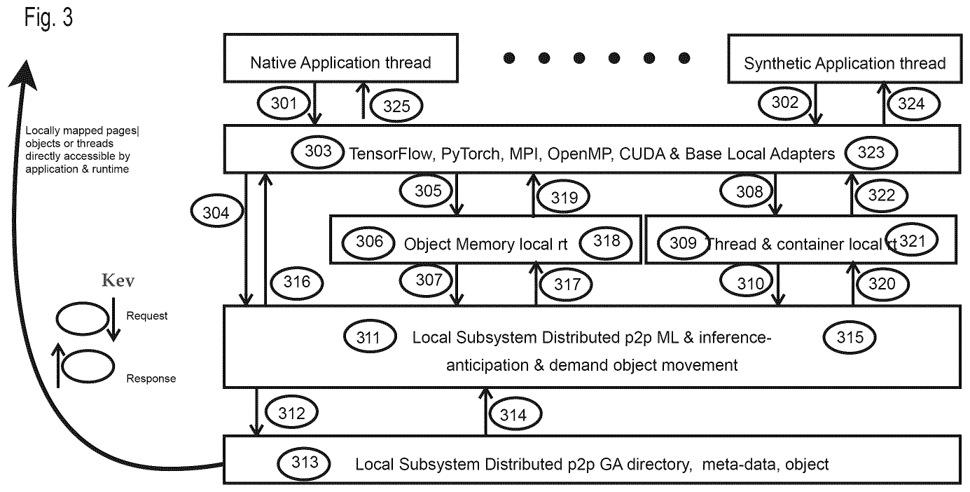

A further appreciation of the invention may be attained by reference to FIG. 3 depicting a preferred method of parallelizing a software application (“Native Application”) according to a further embodiment of the invention. Steps identified in that drawing are described below.

| Step | Action |
|---|---|
| 301 | Native Application 36 thread has a call which is dynamically linked the |
| | adapter 42. Native threads are those specified by the application. This |
| | call can include the base calls to Global Object Memory runtime 52 and |
| | Thread & container runtime 50 as well as other adapter specific |
| | calls. The adapter specific calls would relate to the specific type of |
| | adapter including but not limited to TensorFlow, PyTorch, OpenMPI, |
| | OpenMP or CUDA. |
| 302 | The application 36 starts with at least a single native thread. The |
| | thread & container runtime 50 creates additional synthetic threads to |
| | run the application in parallel. Synthetic threads are those created by |
| | the runtime 50 that were not specified by the application. |
| 303 | Application calls from synthetic threads and base threads are handled |
| | identically. Adapter 42 breaks out behavior into three categories with |
| | a single path for each category. For thread and container related APIs, |
| | path 8 to thread and container runtime 50 is taken. For memory |
| | related APIs, path 5 to global object memory runtime 52 is taken. For |
| | remaining APIs, path 4 directly to ML subsystem 44 is taken. |
| 304 | Direct path from adapter(s) to ML subsystem 44. |
| 305 | Path from adapter 42 to object memory runtime 52 |
| 306 | Object memory runtime 52 execution. There are many local operations |
| | that just return to adapter 42. These are defined by previous ML |
| | subsystem 44 response. |
| 307 | Forward object runtime 52 request to ML subsystem 44. This may or |
| | may not be modified from original request. |
| 308 | Path from adapter 42 to thread runtime 50 |
| 309 | Thread and container runtime 50 execution. There are many local |
| | operations that just return to adapter 42. These are defined by |
| | previous ML subsystem 44 response. |
| 310 | Forward thread runtime 50 request to ML subsystem 44. This may or |
| | may not be modified from original request. |
| 311 | ML compressed transformer model 46 evaluation. In general there is a |
| | response back to one or more of adapter 42, runtimes 50, 52 and |
| | distributed GA directory, serially or in parallel. |
| 312 | Forward ML request to distributed GA directory 48B. |
| 313 | The operation of the distributed GA directory 48B is largely transparent |
| | to the ML subsystem 44 |
| 314 | Response from distributed GA directory 48B. |
| 315 | ML subsystem 44 processes response and will forward a response to |
| | the adapter 44 and/or runtimes 50, 52 and optionally initiate other |
| | distributed GA directory 48B operations. |
| 316 | ML 44 response to adapter 42 |
| 317 | ML 44 response to object memory runtime 52 |
| 318 | Object memory runtime 52 execution of ML command |
| 319 | Object memory runtime 52 response to adapter 42 which either |
| | continues or modifies adapter 42 execution of application 36. |
| 320 | ML 52 response to thread and container runtime 50 |
| 321 | Thread and container runtime 50 execution of ML command |
| 322 | Thread and container runtime 50 response to adapter 42 which either |
| | continues or modifies adapter 42 execution of application 36 |
| 323 | Adapter 42 execution of runtime 50 and ML 44 response |
| 324 | Continue thread execution based on runtime 50 and ML 44 |
| 325 | Continue native thread execution based on runtime 50 and ML 44 |

### Training

Described below are strategies for training decision transformer model 46 of the illustrated embodiment. It will be appreciated that these are provided by way of example and that other types of ML models and/or training methodologies may be used instead or in addition.

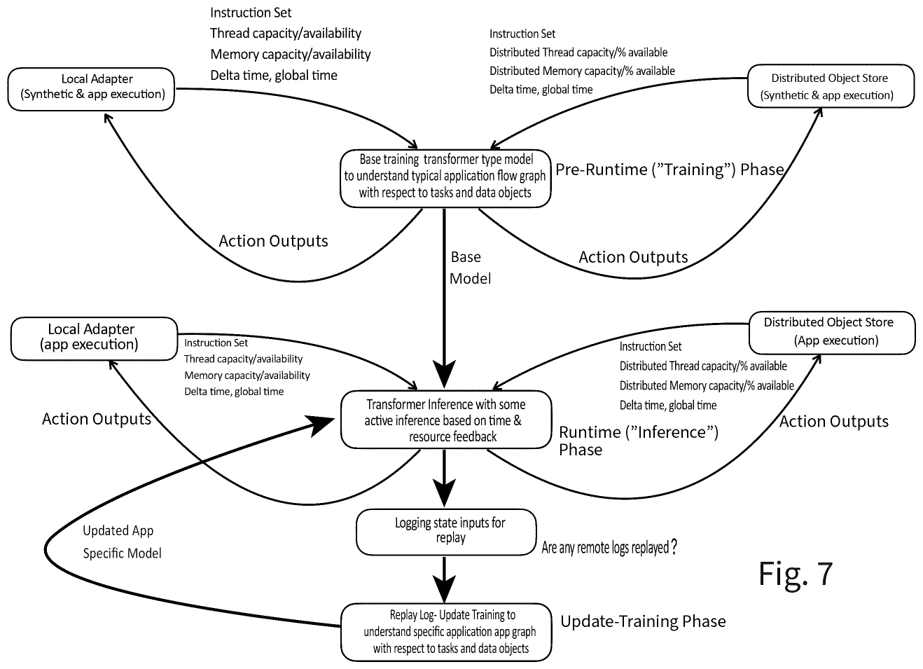

FIG. 7 is a flow diagram depicting training of ML model 46 as a consequence of interaction of the adapters 42, the distributed object store subsystem 48 and the AI engine 44 (and, more particularly, ML model 46) during a training phase prior to runtime, at runtime (during the “inference” phase) and during training-update phases of operation of a system according to the invention. Unless otherwise evident in context, the term “training” as used throughout this application refers to training during any and all of these phases.

Referring to the drawing, during the pre-runtime phase of training, the model 46 is trained to understand generic application flow graphs with respect to tasks and data objects. In the illustrated embodiment, this can be achieved through use of labeled data, unlabeled data and/or synthetically generated data representing execution of one or more sets of instructions other than those on which the system 10 expected to execute during runtime (or, put another way, other than application software 36). In addition to instructions from those instruction sets, resource metrics such as thread capacity/availability (local and distributed, from local adapters 42 and object store 48, respectively), memory capacity/availability (local and distributed, from local adapters 42 and object store 48, respectively), elapsed (delta) time and global time are applied as inputs to the model during training, as shown in the drawing. Action outputs generated by the model 46 are, in turn, applied to the local adapter 42 and local (or distributed) object store 48, also as shown in the drawing.

Application of the aforesaid metrics during training serves as “cost functions” for the model 46, since they reflect increases and decreases in (a) the time required for executing instructions in the instruction sets by the local cores and/or remote nodes in response to generation of action outputs, as well as the hardware (memory and processor/thread) resources consumed in executing those instructions in response to those action outputs.

In some embodiments, the model 46 is also trained during the pre-runtime phase with labeled and/or unlabeled data representing execution of the application software 36 on which the system 10 is expected to execute during runtime. More typically, however, training with respect to that data occurs during the runtime or inference phase of operation of system 10, i.e., when it is executing application software 36 in real time. As a consequence, that phase of training more typically utilizes unlabeled data.

With continued reference to FIG. 7, during the runtime (or inference) phase of training, the model 46 is trained with active inference based on the aforesaid time and resource metrics, which are applied to the model 46 by the local adapters 42 and object store subsystem 48 in this phase, as well.

Here, too, the aforesaid metrics serve as “cost functions” (labeled “resource feedback,” in the drawing) for the model 46, since they reflect increases and decreases in (a) the time required for executing instructions in the application software 36 by the local cores and/or remote nodes in response to generation of action outputs, as well as the hardware (memory and processor/thread) resources consumed in executing those instructions in response to those action outputs.

During the runtime phase, inputs to the model 46 are logged, along with its action outputs. These are used in the update training phase, during which those logs are replayed to train the model 46 further by permitting it to understand flow graphs with respect to tasks and data objects, here, however, with particular respect to application software 36 that had been executed during the runtime.

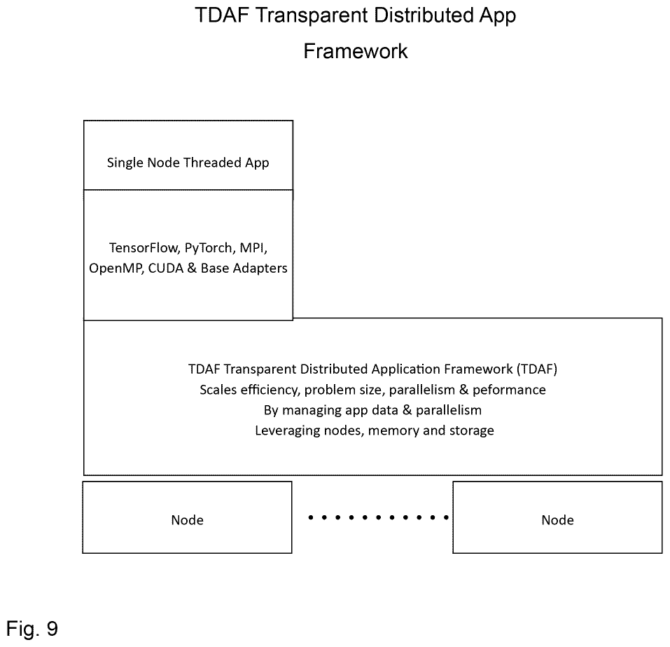

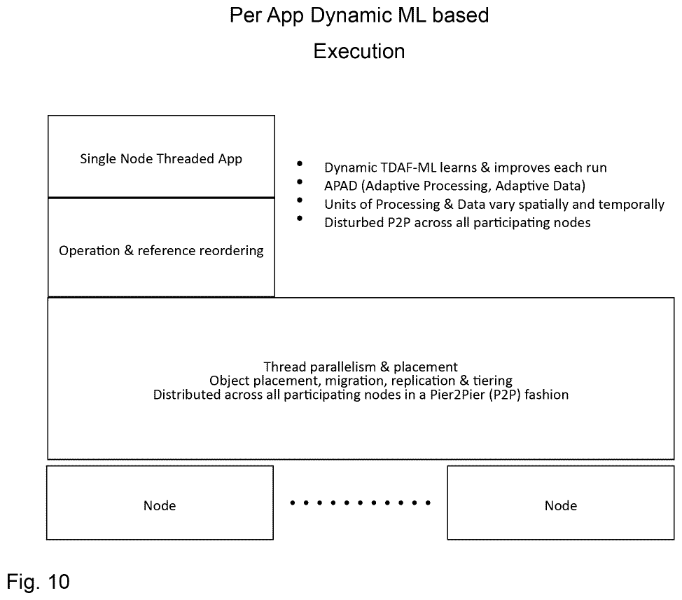

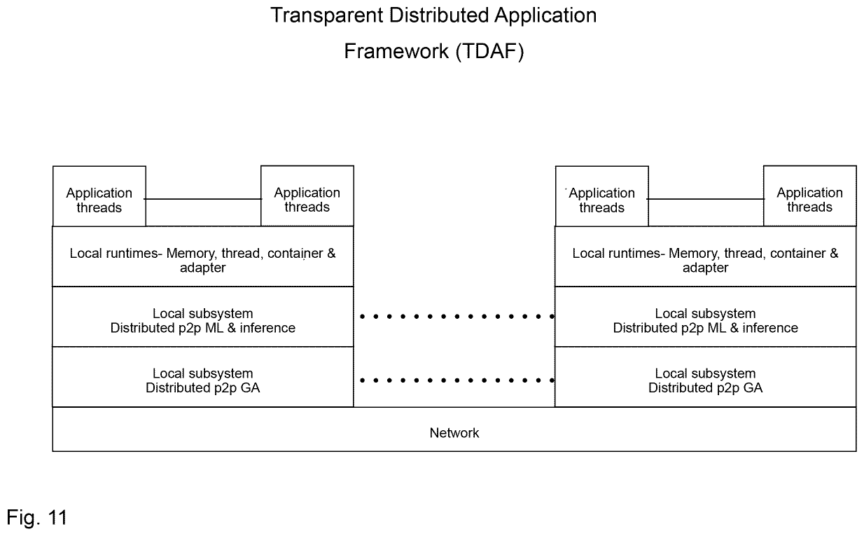

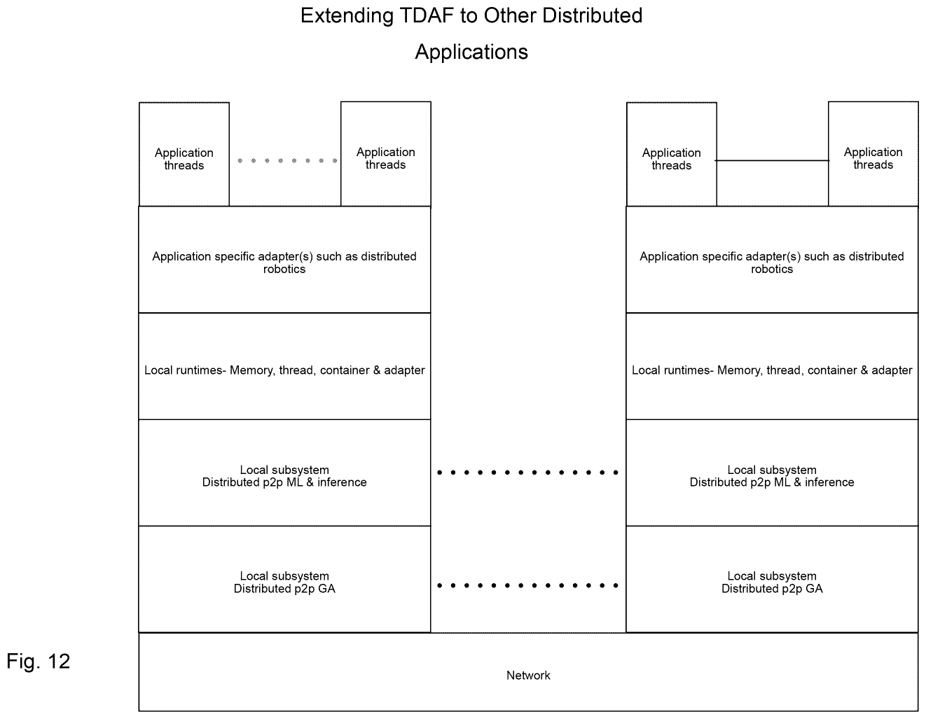

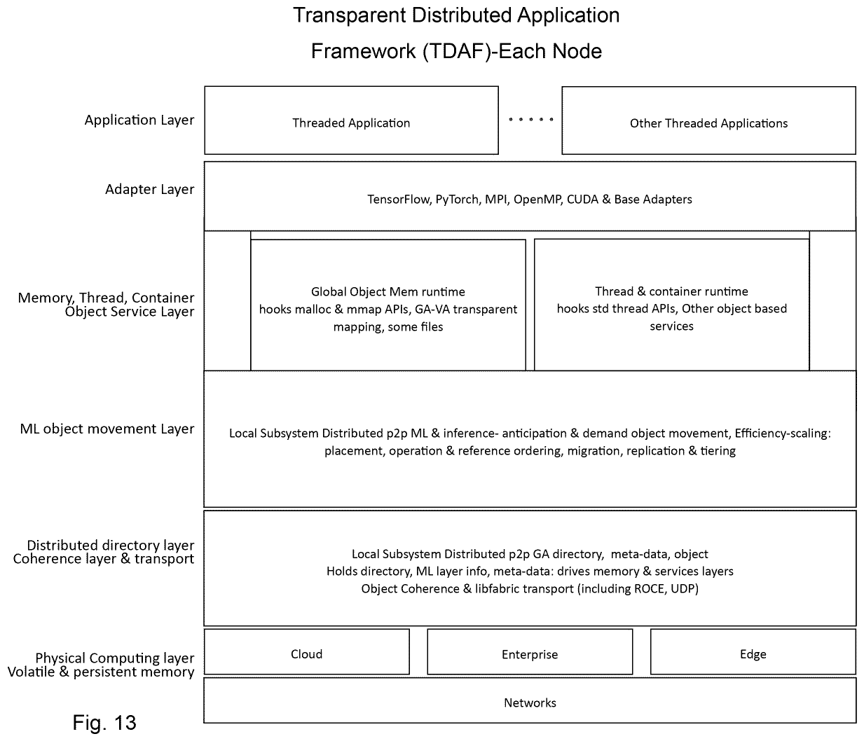

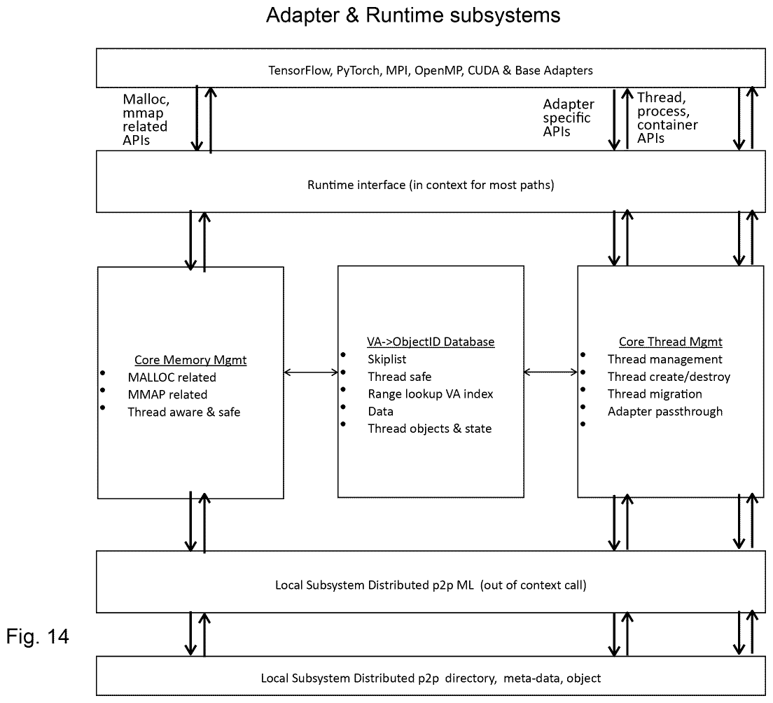

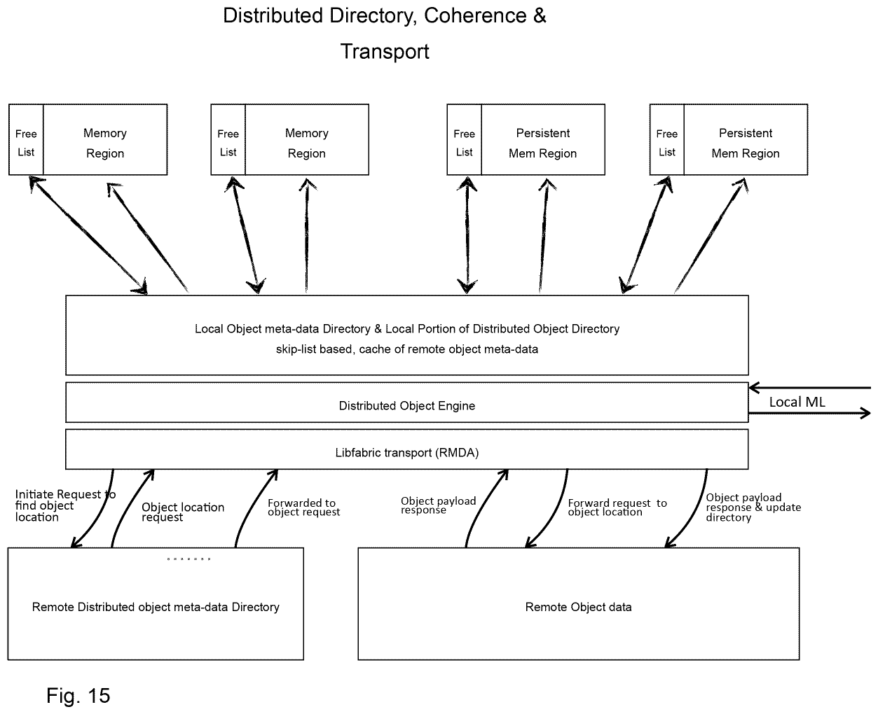

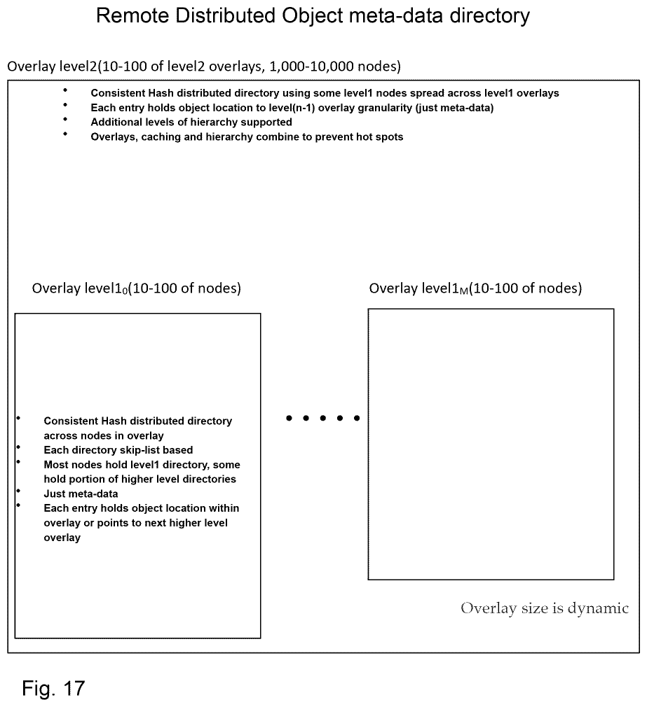

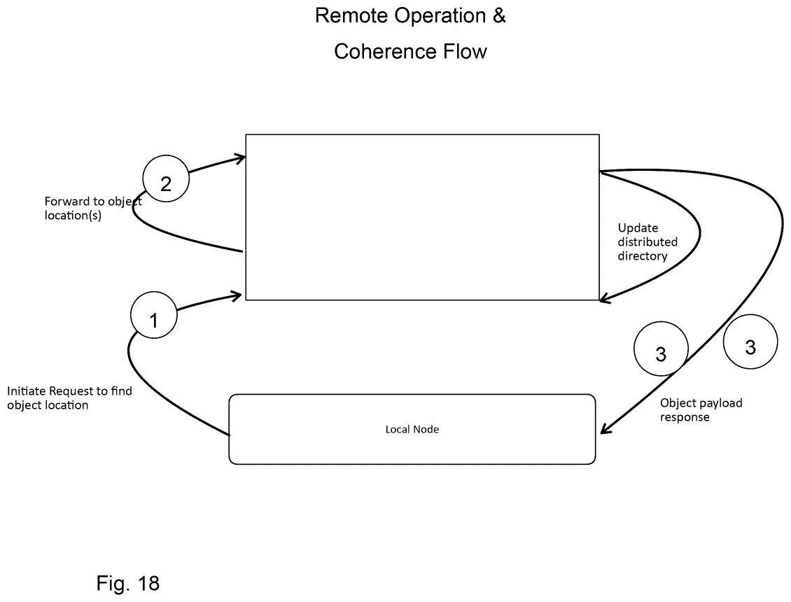

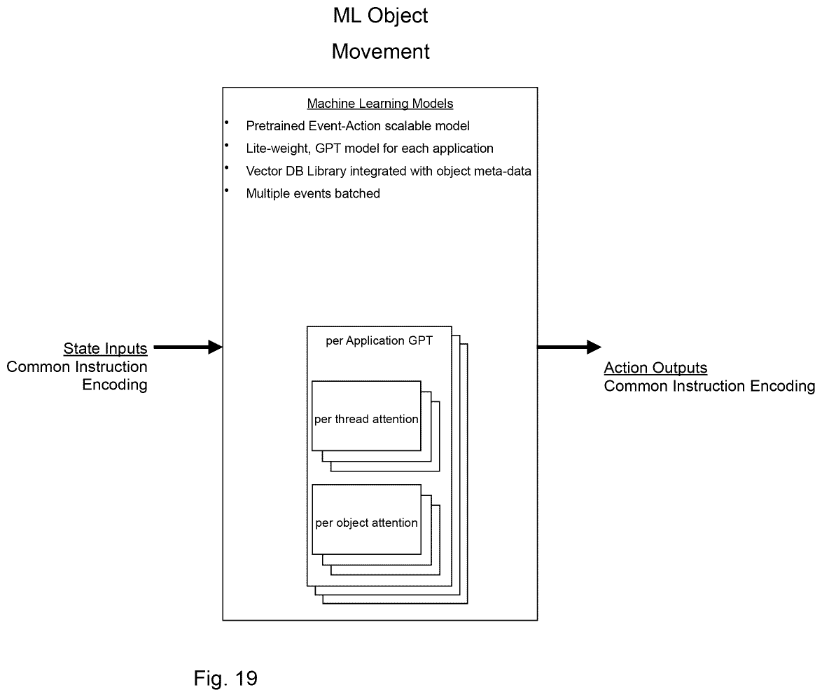

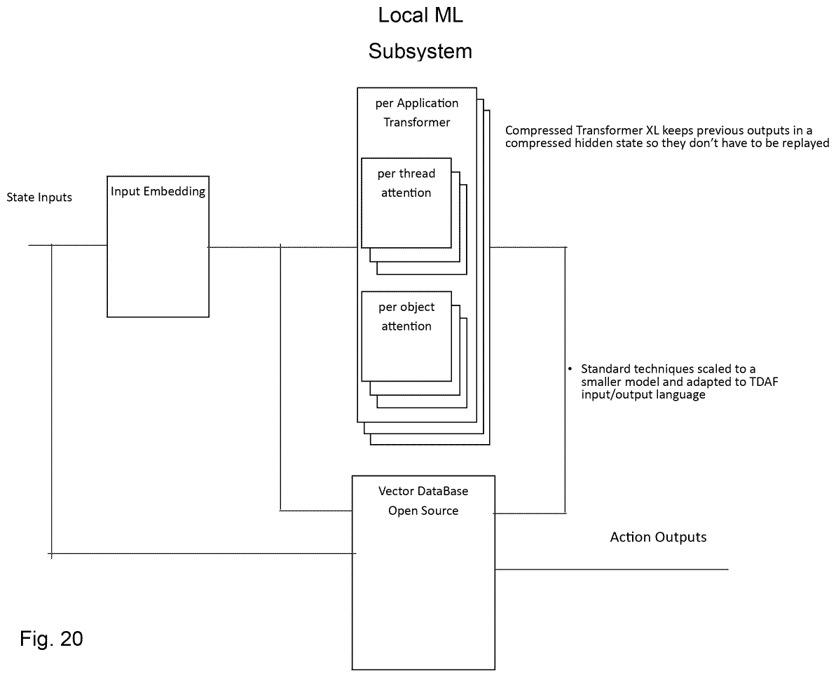

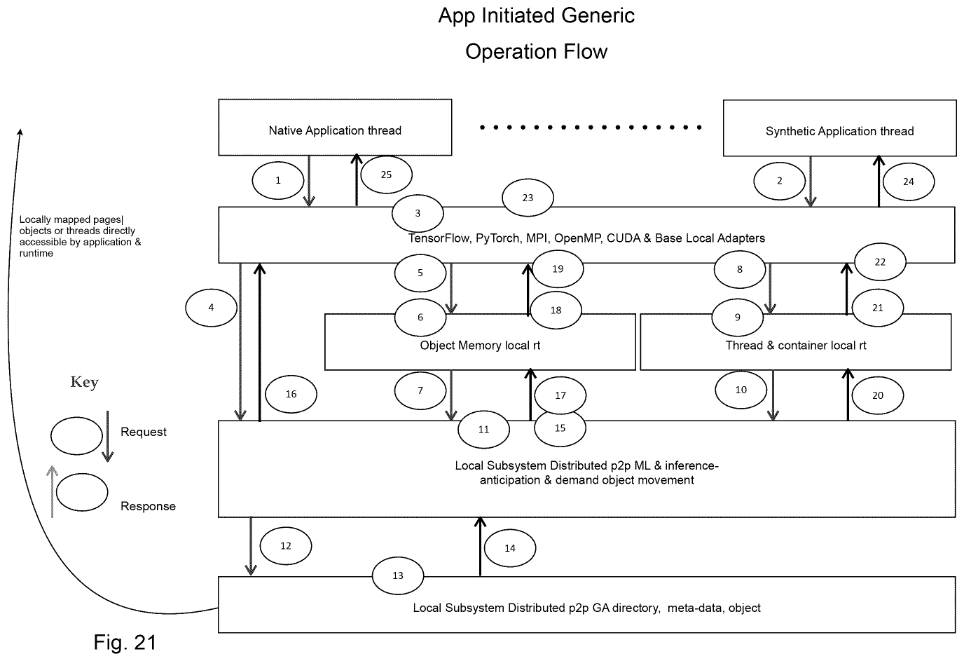

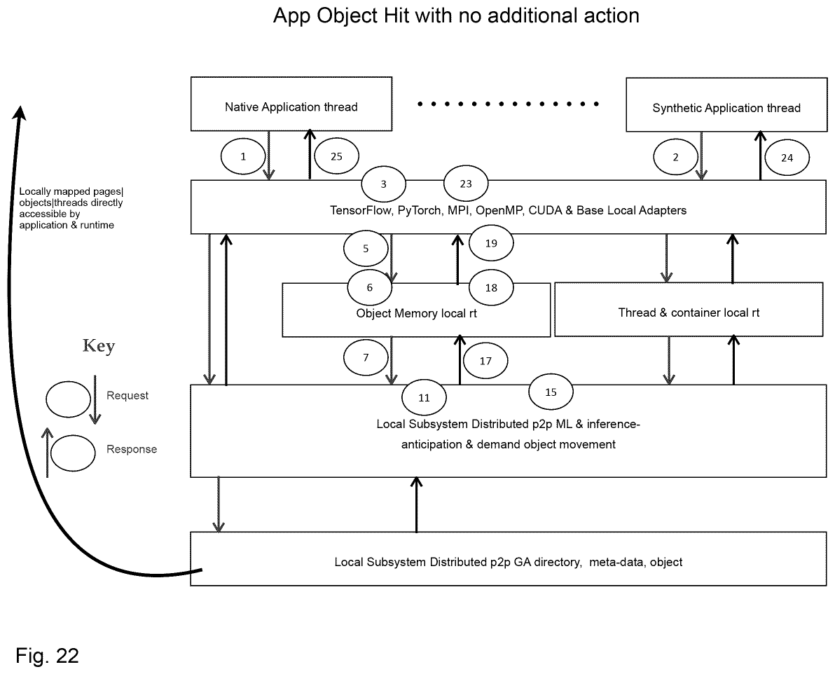

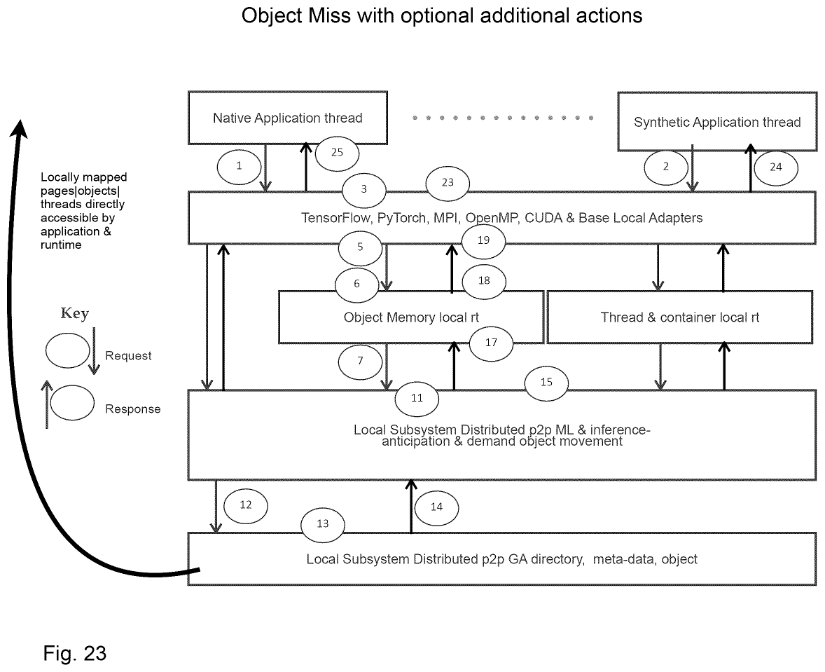

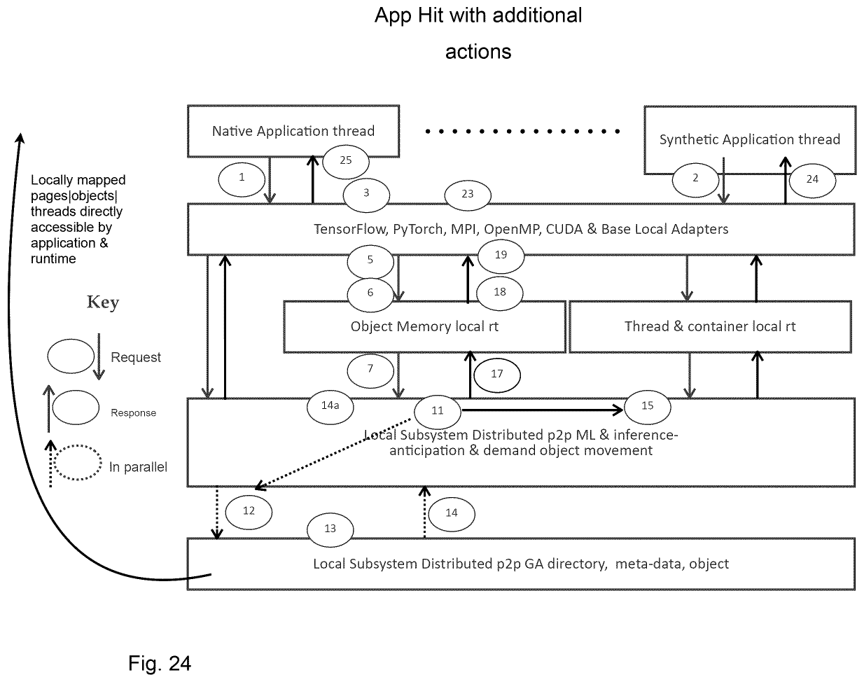

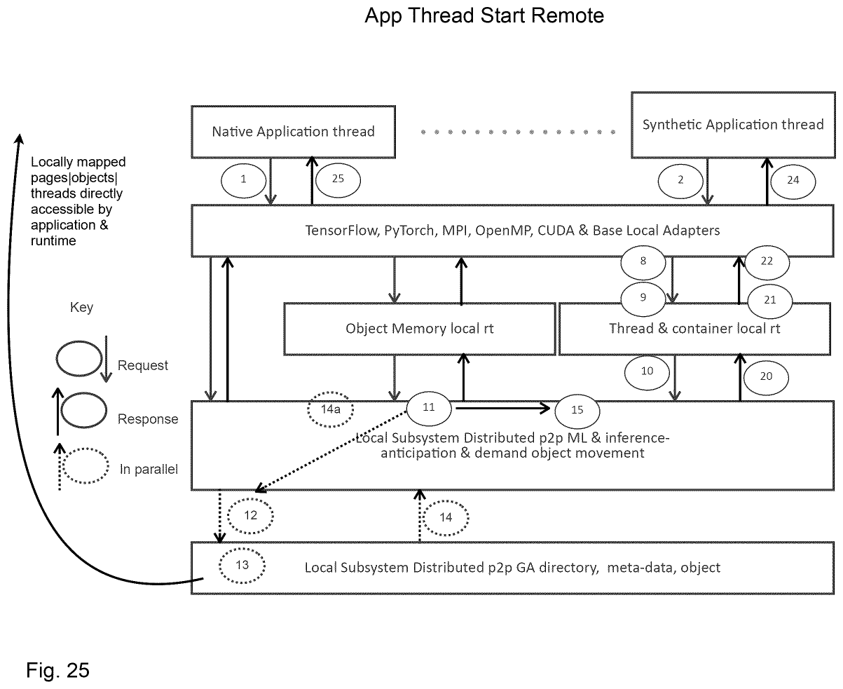

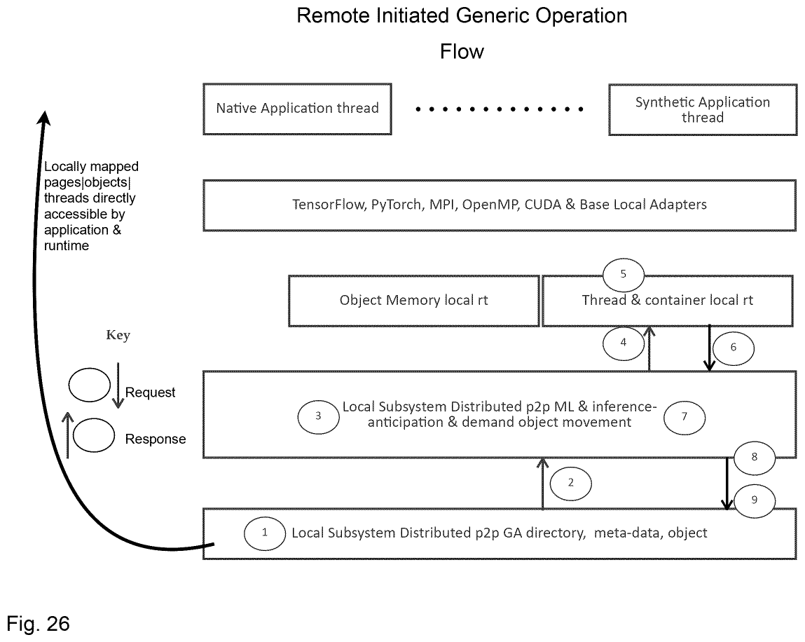

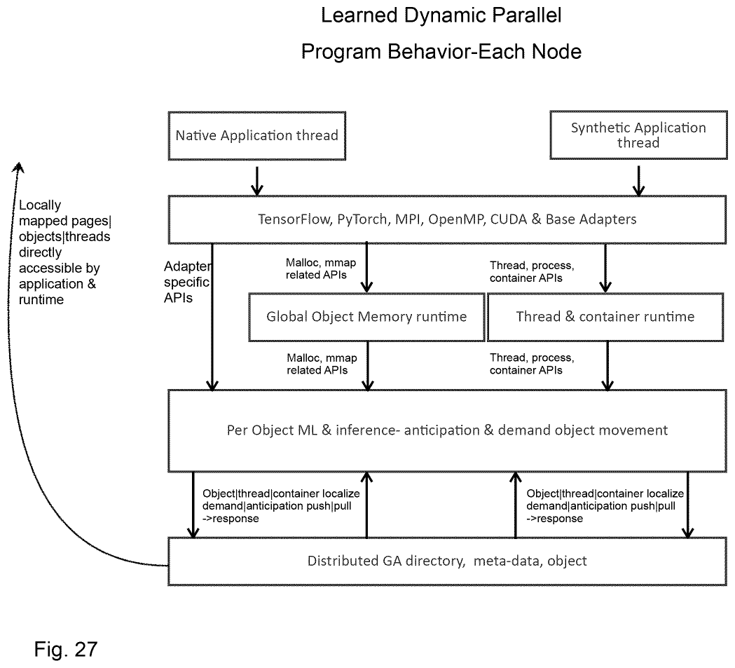

A further appreciation of the architecture and operation of systems according to the invention may be attained by reference to FIGS. 9-27, where, in FIGS. 21-26, the numbers in circles represent an order of operations and data/instruction/control flow between the respective illustrated elements.

### CONCLUSION

Described above are systems and methods for automated distribution of software applications for parallel (and serial) execution on multi-core and/or multi-nodal digital systems. It will be appreciated that the embodiments described herein are merely examples of the invention, and that other embodiments varying from that shown here, yet, in the spirit thereof, fall within the scope of the invention. Thus, for example, although the discussion above focused on distributing (or otherwise making available) and executing a single software application over a plurality of cores and nodes, the invention is equally applicable to doing so for a software “system” comprising multiple such applications. Likewise, by way of further example, although much of the discussion above focuses on distributing software and data for parallel execution on local and remote cores, that discussion is equally applicable to distributing that software and data for execution in series by such cores.

In view of the foregoing, what we claim is:

1. A method of executing software on a digital system with multiple processing elements that are coupled for communications via communications media, comprising
A. executing software on a first processing element of a digital system to process a set of data, where the digital system comprises multiple processing elements, including the first processing element, that are coupled for communications via communications media,
B. any of detecting and intercepting (collectively, “intercepting”) one or more instructions executed by the first processing element during and as a result of its execution of the software,
C. applying a representation of one or more of the intercepted instructions to an artificial intelligence (AI) engine to generate, using a machine learning (ML) model executing on that AI engine, one or more action outputs of the ML model comprising commands to effect further execution of the software on multiple processing elements of the digital system,
D. generating based on those action outputs one or more objects that
(i) are associated with instructions making up at least a portion of the software upon which such further execution is to be effected, and
(ii) at least a subset of the set of data, in an address space common to the multiple processing elements, to be processed by those associated instructions, and
E. making available any of action outputs and objects to the multiple processing elements to effect such further execution.

2. The method of claim 1, where step (C) comprises using the ML model executing on the AI engine to generate one or more action outputs to effect said further execution within any of (i) said first processing element and (ii) one or more other processing elements.

3. The method of claim 1, comprising performing each of steps (A)-(C) on multiple processing elements of the multiprocessing element digital system.

4. The method of claim 3, comprising executing step (C) on each of the multiple processing elements using a said AI engine local to that processing element.

5. The method of claim 1, wherein step (C) includes generating the one or more action outputs to effect movement of data associated with one or more of the objects to said one or more other processing elements.

6. The method of claim 5, comprising performing a step of responding on a given said processing element of said multiprocessing element digital system to one or more objects generated by another said processing element of that system by further executing the software using any of data and instructions associated with a said object.

7. The method of claim 6, where the step of effecting further execution of the software on the given processing element comprises effecting execution of one or more of the intercepted instructions or a modified form thereof.

8. The method of claim 5, wherein the multiple processing elements of the digital system access said objects using a common address space.

9. The method of claim 1, wherein the ML model is based on any of a decision transformer or reinforcement learning (RL).

10. The method of claim 1, wherein the ML model is trained with labeled data, unlabeled data and/or synthetic generated data representing execution of a set of one or more instructions other than those defining the software.

11. The method of claim 1, wherein the ML model is trained during any of pre-runtime, runtime and update-training phases of execution of the software with any of labeled data and unlabeled data representing execution of the software.

12. The method of claim 1, wherein the ML model is trained during any of pre-runtime, runtime and update-training phases of execution of the software using, as a cost function, any of
(a) a period of time for effecting further execution of the software on one or more of the processing elements,
(b) an amount of resources required for effecting further execution of the software on one or more of the processing elements, and
(c) a number of processing elements required for effecting further execution of the software.

13. The method of claim 1, wherein
step (C) includes logging inputs applied to the ML model and outputs generated by the model, and the method further comprises replaying the logged input and outputs to train the model during an update-training phase.

14. The method of claim 1, wherein step (C) includes generating the one or more action outputs to effect execution of one or more of the intercepted instructions or a modified form thereof on said one or more other processing elements of said multiprocessing element digital system.

15. The method of claim 14, comprising performing a step of responding on a given said processing element of said multiprocessing element digital system to one or more objects generated by another said processing element of that system by further executing the software on the given processing element using any of data and instructions associated with a said object.

16. The method of claim 1, wherein step (C) includes generating the one or more action outputs to effect execution of one or more of the intercepted instructions or a modified form thereof on said first processing element.

17. The method of claim 1, wherein step (C) includes (i) generating the one or more objects to effect execution of one or more of the intercepted instructions or a modified form thereof on said one or more other processing elements of said digital system, and (ii) generating the one or more action outputs to effect execution of one or more of the intercepted instructions or a modified form thereof on said first processing element.

18. A method of executing software on a digital system with multiple processing elements, comprising
A. executing a software application on a first processing element of a digital system to process a set of data, where the digital system comprises multiple processing elements, including the first processing element, that are coupled by communications media,
B. any of detecting and intercepting (collectively, “intercepting”) one or more instructions executed by the first processing element during and as a result of its execution of the software application,
C. applying a representation of one or more of the intercepted instructions to an artificial intelligence (AI) engine local to the first processing element to generate, using a machine learning (ML) model executing on that AI engine, one or more action outputs of the ML model comprising commands to effect further execution of the software application on multiple processing elements of the digital system,
D. generating based on those action outputs one or more objects that (a) are associated with instructions making up the at least the portion of the software application upon which such further execution is to be effected, and (b) are associated with at least a subset of the set of data, in an address space common to the multiple processing elements, to be processed by those associated instructions,
E. making available one or more of the action outputs and one or more of the objects to the multiple processing elements for processing thereby, and
F. performing each of steps (A)-(E) on each of said one or more other processing elements of the digital system using a said AI engine local to that processing element.

19. A method of executing software on a digital system with multiple processing elements, comprising
A. executing a software application on a plurality of processing elements of a digital system to process a set of data,
B. any of detecting and intercepting (collectively, “intercepting”) on each of the plurality of processing elements one or more instructions executed by that processing element during and as a result of that processing element's execution of the software application, and
C. with each of said plurality of processing elements, applying a representation of one or more of the instructions intercepted during execution of the software application on that processing element to an artificial intelligence (AI) engine local to that processing element to generate, using a machine learning (ML) model executing on that AI engine, one or more action outputs of the ML model comprising commands to effect further execution of the software application on (i) that processing element and (ii) one or more others of the plurality of processing elements of the system,
D. with at least one of said plurality of processing elements, generating based on those action outputs one or more objects that (a) are associated with instructions making up the at least the portion of the software application upon which such further execution is to be effected, and (b) are associated with data in an address space common to the multiple processing elements to be processed by those associated instructions,
E. making available one or more of the action outputs and one or more of the objects to the multiple processing elements for processing thereby.

20. The method of claim 19, comprising performing a step of responding on a given said processing element of said multiprocessing element digital system to one or more objects generated by another said processing element of that system by effecting further execution of the software application on the given processing element using any of data and instructions associated with a said object.

21. The method of claim 20, where the step of effecting further execution of the software application on the given processing element comprises effecting execution of one or more of the intercepted instructions or a modified form thereof.

22. The method of claim 19, wherein the ML model of the AI engine of each of the processing elements of the system is based on any of a decision transformer or reinforcement learning (RL).

23. The method of claim 22, wherein the ML model of the AI engine of each of the processing elements of the system is trained with labeled data, unlabeled data and/or synthetic generated data representing execution of a set of one or more instructions other than those defining the software.

24. The method of claim 22, wherein the ML model of the AI engine of each of the processing elements of the system is trained during any of pre-runtime, runtime and update-training phases of execution of the software application with any of labeled data and unlabeled data representing execution of the software application.

25. The method of claim 22, wherein the ML model of the AI engine of each of the processing elements of the system is trained during any of pre-runtime, runtime and update-training phases of execution of the software application using, as a cost function, any of
(a) a period of time for effecting further execution of the software application on one or more of the processing elements of the system,
(b) an amount of resources required for effecting further execution of the software application in response to one or more of the action outputs, or objects based thereon, on one or more of the processing elements of the system, and
(c) a number of processing elements required for effecting further execution of the software application in response to one or more of the action outputs, or objects based thereon.

26. The method of claim 22, wherein
step (C) includes logging inputs applied to the ML model and outputs generated by the model, and the method further comprises
replaying the logged input and outputs to train the model during an update-training phase.

27. A method of executing software on a digital system with multiple processing elements that are coupled for communications, comprising
A. executing software on a processing element of a digital system that comprises multiple processing elements,
B. with that processing element, applying a representation of one or more instructions of the executing software to an artificial intelligence (AI) engine executing on that processing element to generate one or more first action outputs comprising commands to effect further execution of the software on multiple processing elements of the digital system, and
C. with an other said processing element of the digital system, generating with an AI engine executing on that other processing element one or more further action outputs comprising commands to effect said further execution of the software.

28. The method of claim 27, comprising performing step (C) on multiple processing elements of the system.

29. The method digital of claim 27, comprising performing each of steps (A)-(C) on multiple processing elements of the digital system.

30. The method of claim 27, wherein step (B) comprises making one or more of the first action outputs or constructs based thereon available to said other processing element.

31. The method of claim 30, wherein a said construct includes one or more objects that
(i) are associated with instructions making up at least a portion of the software upon which such further execution is to be effected, and
(ii) are associated with at least a subset of the set of data, in an address space common to the multiple processing elements, to be processed by those associated instructions.

32. The method of claim 30, comprising making said one or more first action outputs or constructs based thereon available to said other processing element by way of communications media.

33. The method of claim 27, wherein each of the AI engines comprises a respective learning (ML) model that generates action outputs.

34. The method of claim 27, wherein the software comprises one or more software applications.

35. The method of claim 27, wherein step (B) includes making action outputs available to the one or more other processing elements via communications media.

36. A method of executing software on a digital system with multiple processing elements that are coupled for communications, comprising
A. executing software on a processing element of a digital system that comprises multiple processing elements,
B. with that processing element, applying a representation of one or more instructions of the executing software to an artificial intelligence (AI) engine executing on that processing element to generate one or more first action outputs comprising commands to effect further execution of the software on multiple processing elements of the digital system, and
C. with an other said processing element of the digital system, effecting that further execution of said software by executing at least a portion thereof based on generation of said one or more first action outputs.

37. The method of claim 36, comprising performing step (C) on multiple processing elements of the digital system.

38. The method of claim 36, comprising
D. with that other processing element, applying a representation of one or more instructions of said software executing on that other processing element to an artificial intelligence (AI) engine executing on that other processing element to generate one or more further action outputs comprising commands to effect further execution of the software on multiple processing elements of the digital system.

39. The method of claim 38, comprising performing steps (C)-(D) on multiple processing elements of the digital system.

40. The method of claim 36, wherein step (B) comprises making one or more of the first action outputs or constructs based thereon available to said other processing element.

41. The method of claim 40, wherein a said construct includes one or more objects that
(i) are associated with instructions making up at least a portion of the software upon which such further execution is to be effected, and
(ii) at least a subset of the set of data, in an address space common to the multiple processing elements, to be processed by those associated instructions.

42. The method of claim 40, comprising making said one or more first action outputs or constructs based thereon available to said other processing element by way of communications media.

43. The method of claim 36, wherein each of the AI engines comprises a respective learning (ML) model that generates action outputs.

44. The method of claim 36, wherein the software comprises one or more software applications.

45. The method of claim 36, wherein step (B) includes making action outputs available to the one or more other processing elements via communications media.

46. The method of claim 36, where each said processing element comprises any of (i) one or more processor cores, including at least one central processing unit (CPU) core, graphics processing unit (GPU) core and/or specialized processing unit (SPU) core, (ii) a virtualization container executing on one or more processor cores, (iii) a virtual machine executing on such cores, and/or (iv) a combination of the foregoing.

47. The method of claim 46, where each said CPU, GPU and/or SPU (i) accesses local memory and I/O logic of the respective processing element by way of a shared local bus or backplane, and/or (ii) collectively, execute a single instance of an operating system.

48. The method of claim 1, where each said processing element comprises any of (i) one or more processor cores, including at least one central processing unit (CPU) core, graphics processing unit (GPU) core and/or specialized processing unit (SPU) core, (ii) a virtualization container executing on one or more processor cores, (iii) a virtual machine executing on such cores, and/or (iv) a combination of the foregoing.

49. The method of claim 48, where each said CPU, GPU and/or SPU (i) accesses local memory and I/O logic of the respective processing element by way of a shared local bus or backplane, and/or (ii) collectively, execute a single instance of an operating system.

50. The method of claim 18, where each said processing element comprises any of (i) one or more processor cores, including at least one central processing unit (CPU) core, graphics processing unit (GPU) core and/or specialized processing unit (SPU) core, (ii) a virtualization container executing on one or more processor cores, (iii) a virtual machine executing on such cores, and/or (iv) a combination of the foregoing.

51. The method of claim 50, where each said CPU, GPU and/or SPU (i) accesses local memory and I/O logic of the respective processing element by way of a shared local bus or backplane, and/or (ii) collectively, execute a single instance of an operating system.

52. The method of claim 19, where each said processing element comprises any of (i) one or more processor cores, including at least one central processing unit (CPU) core, graphics processing unit (GPU) core and/or specialized processing unit (SPU) core, (ii) a virtualization container executing on one or more processor cores, (iii) a virtual machine executing on such cores, and/or (iv) a combination of the foregoing.

53. The method of claim 52, where each said CPU, GPU and/or SPU (i) accesses local memory and I/O logic of the respective processing element by way of a shared local bus or backplane, and/or (ii) collectively, execute a single instance of an operating system.

54. The method of claim 26, where each said processing element comprises any of (i) one or more processor cores, including at least one central processing unit (CPU) core, graphics processing unit (GPU) core and/or specialized processing unit (SPU) core, (ii) a virtualization container executing on one or more processor cores, (iii) a virtual machine executing on such cores, and/or (iv) a combination of the foregoing.

55. The method of claim 54, where each said CPU, GPU and/or SPU (i) accesses local memory and I/O logic of the respective processing element by way of a shared local bus or backplane, and/or (ii) collectively, execute a single instance of an operating system.

56. The method of claim 27, where each said processing element comprises any of (i) one or more processor cores, including at least one central processing unit (CPU) core, graphics processing unit (GPU) core and/or specialized processing unit (SPU) core, (ii) a virtualization container executing on one or more processor cores, (iii) a virtual machine executing on such cores, and/or (iv) a combination of the foregoing.

57. The method of claim 56, where each said CPU, GPU and/or SPU (i) accesses local memory and I/O logic of the respective processing element by way of a shared local bus or backplane, and/or (ii) collectively, execute a single instance of an operating system.
